(19) United States
(12) Patent Application Publication
(10) Pub. No.: US 2024/0267950 A1
(43) Pub. Date: Aug. 8, 2024

(54) METHOD AND APPARATUS FOR TRANSMITTING AND RECEIVING SIDELINK FEEDBACK INFORMATION

(71) Applicant: FUJITSU LIMITED, Kawasaki-shi Kanagawa (JP)

(72) Inventors: Jian ZHANG, Beijing (CN); Qinyan JIANG, Beijing (CN); Pengyu JI, Beijing (CN); Guorong LI, Beijing (CN); Xin WANG, Beijing (CN)

(73) Assignee: FUJITSU LIMITED, Kawasaki-shi Kanagawa (JP)

(21) Appl. No.: 18/637,765

(22) Filed: Apr. 17, 2024

Related U.S. Application Data
(63) Continuation of application No. PCT/CN2021/124985, filed on Oct. 20, 2021.

(51) Int. Cl. H04W 74/0816; H04L 5/00; H04W 72/25; H04W 74/00

(52) U.S. Cl. CPC H04W 74/0816; H04L 5/0053; H04W 72/25; H04W 74/006

(57) ABSTRACT

A method and an apparatus for transmitting and receiving sidelink feedback information. For HARQ-ACK retransmission from a first device to a network device, if the first device has transmitted a PSCCH and/or PSSCH associated with HARQ-ACK to a second device, but has not received sidelink feedback information needing to be carried by the PUCCH, the first device does not transmit the PUCCH to the network device, thereby unnecessary occupation of an unlicensed frequency band can be reduced or avoided, and the network device can be notified to schedule HARQ-ACK retransmission. For HARQ-ACK retransmission from the second device to the first device, a size of a HARQ-ACK codebook is additionally used to determine a PSFCH resource, so as to avoid a PSFCH resource collision during HARQ-ACK retransmission of multicast.

### CROSS-REFERENCE TO RELATED APPLICATION

This application is a continuation application of International Application PCT/CN2021/124985, filed on Oct. 20, 2021, and designated the U.S., the entire contents of which are incorporated herein by reference.

### TECHNICAL FIELD

The embodiments of the present disclosure relate to the communication technology field.

### BACKGROUND

3GPP has standardized how to use unlicensed frequency bands for Uu interfaces. The standardization work of 5G NR mainly includes NR—U items of Release 16 and 52.6 GHz-71 GHz items of Release 17 in progress. Technically, using of unlicensed frequency bands increases spectrum resources available to the Uu interfaces, and these additional spectrum resources are conducive to improving a data rate (or throughput), improving reliability, and reducing time delay, etc. In terms of application, an unlicensed frequency band may be jointly deployed with a licensed frequency band, the licensed frequency band is used to assist the use of the unlicensed frequency band, or the unlicensed frequency band may be deployed independently. Relevant application scenarios include any scenario co-existing with other wireless access technologies (such as WIFI), an Industrial Internet of Things (IIOT) scenario using unlicensed frequency bands, etc.

3GPP has standardized sidelinks, and the standardization work of 5G NR includes the V2x items of Release 16 and sidelink items of Release 17 in progress. A physical channel defined by Rel-16 NR V2X includes a Physical Sidelink Control Channel (PSCCH), a Physical Sidelink Shared Channel (PSSCH) and a Physical Sidelink Feedback Channel (PSFCH). The PSCCH carries 1st stage Sidelink Control Information (SCI), the 1st stage SCI is mainly used for reserving one or more resources. The PSSCH carries 2nd stage SCI and one or more Transport Blocks (TBs), wherein the 2nd stage SCI is mainly used for TB demodulation.

The PSFCH carries sidelink feedback information (which may be called HARQ-ACK). The PSCCH and the PSSCH are generally transmitted in a same slot. One PSCCH/PSSCH is associated with one or more PSFCH resources according to established rules. After transmitting the PSCCH/PSSCH, a device may receive an acknowledgment (ACK)/non-acknowledgment (NACK) on an associated PSFCH resource. NR V2X supports HARQ-ACK feedbacks for unicast and multicast. Multicast further includes two HARQ-ACK feedback modes: HARQ Option 1 and HARQ Option 2.

For multicast with HARQ Option 1, only a receiving device within a certain communication range will feed back HARQ-ACK, and uses a mode which only feeds back NACK (NACK-only), and a transmitting device does not know which specific receiving device transmits NACK. For multicast with HARQ Option 2, PSFCH resources for feeding back ACK/NACK by each receiving device are independent, and a transmitting device knows which receiving device transmits the ACK/NACK.

Resources (time-frequency resources) used for sidelink transmission are located in a resource pool. NR V2X defines two operation modes. For NR V2X mode 1 (Mode 1), a resource used by a terminal equipment for V2X communication is scheduled or configured by a network device (base station) via a NR Uu link. For NR V2X mode 2 (Mode 2), a terminal equipment may autonomously select a time-frequency resource for V2X communication based on a sensing result.

It should be noted that the above introduction to the technical background is just to facilitate a clear and complete description of the technical solutions of the present disclosure, and is elaborated to facilitate the understanding of persons skilled in the art. It cannot be considered that the above technical solutions are known by persons skilled in the art just because these solutions are elaborated in the Background of the present disclosure.

### SUMMARY

The inventor finds that 3GPP is currently discussing items of Release 18, and SL-U (Sidelink-Unlicensed) is one of candidate items. For the SL-U, HARQ-ACK retransmission is also one of the necessary functions. How to support HARQ-ACK retransmission in the SL-U is still an open problem.

For at least one of the above problems, the embodiments of the present disclosure provide a method and an apparatus for transmitting and receiving sidelink feedback information.

According to one aspect of the embodiments of the present disclosure, a method for transmitting sidelink feedback information is provided, comprising:
in a case where a physical uplink control channel (PUCCH) needs to be transmitted to a network device, determining, by a first device, whether sidelink feedback information needing to be carried by the physical uplink control channel is received, and whether a physical sidelink control channel (PSCCH) and/or a physical sidelink shared channel (PSSCH) associated with the sidelink feedback information has/have been transmitted to a second device; and
not transmitting, by the first device, the physical uplink control channel (PUCCH) in a case where the sidelink feedback information needing to be carried by the physical uplink control channel is not received and the physical sidelink control channel (PSCCH) and/or the physical sidelink shared channel (PSSCH) associated with the sidelink feedback information has/have been transmitted to the second device.

According to another aspect of the embodiments of the present disclosure, an apparatus for transmitting sidelink feedback information is provided, including:
a determining unit configured to, in a case where a physical uplink control channel needs to be transmitted to a network device, determine whether sidelink feedback information needing to be carried by the physical uplink control channel is received, and whether a physical sidelink control channel and/or a physical sidelink shared channel associated with the sidelink feedback information has/have been transmitted to a second device; and
a processing unit configured to not to transmit the physical uplink control channel in a case where the sidelink feedback information needing to be carried by the physical uplink control channel is not received and the physical sidelink control channel and/or the physical sidelink shared channel associated with the sidelink feedback information has/have been transmitted to the second device.

According to another aspect of the embodiments of the present disclosure, a method for transmitting sidelink feedback information is provided, including:
receiving, by a second device, a physical sidelink control channel (PSCCH) and/or physical sidelink shared channel (PSSCH) transmitted by a first device; and
transmitting, by the second device, a plurality of sidelink feedback information to the first device, wherein physical sidelink feedback channel (PSFCH) resources of the plurality of sidelink feedback information are determined at least according to the number of the plurality of sidelink feedback information.

According to another aspect of the embodiments of the present disclosure, an apparatus for transmitting sidelink feedback information is provided, including:
a receiving unit configured to receive a physical sidelink control channel and/or physical sidelink shared channel transmitted by a first device; and
a transmitting unit configured to transmit a plurality of sidelink feedback information to the first device, wherein physical sidelink feedback channel resources of the plurality of sidelink feedback information are determined at least according to the number of the plurality of sidelink feedback information.

According to another aspect of the embodiments of the present disclosure, a communication system is provided, including:
a first device configured to, in a case where a physical uplink control channel needs to be transmitted to a network device, determine whether sidelink feedback information needing to be carried by the physical uplink control channel is received, and whether a physical sidelink control channel and/or a physical sidelink shared channel associated with the sidelink feedback information has/have been transmitted to a second device, and not to transmit the physical uplink control channel in a case where the sidelink feedback information needing to be carried by the physical uplink control channel is not received and the physical sidelink control channel and/or the physical sidelink shared channel associated with the sidelink feedback information has/have been transmitted to the second device; and/or
a second device configured to receive a physical sidelink control channel and/or physical sidelink shared channel transmitted by the first device, and transmit a plurality of sidelink feedback information to the first device, wherein physical sidelink feedback channel resources of the plurality of sidelink feedback information are determined at least according to the number of the plurality of sidelink feedback information.

One of the advantageous effects of the embodiments of the present disclosure is: for HARQ-ACK retransmission from a first device to a network device, if the first device has transmitted a PSCCH and/or PSSCH associated with HARQ-ACK to a second device, but has not received sidelink feedback information needing to be carried by the PUCCH (i.e., the PUCCH does not contain a valid HARQ-ACK bit), the first device does not transmit the PUCCH to the network device, thereby unnecessary occupation of an unlicensed frequency band can be reduced or avoided, and the network device can be notified to schedule HARQ-ACK retransmission. For HARQ-ACK retransmission from the second device to the first device, a size of a HARQ-ACK codebook is additionally used to determine a PSFCH resource, so as to avoid a PSFCH resource collision during HARQ-ACK retransmission of multicast.

Referring to the later description and drawings, specific implementations of the present disclosure are disclosed in detail, indicating a manner that the principle of the present disclosure can be adopted. It should be understood that the implementations of the present disclosure are not limited in terms of the scope. Within the scope of the spirit and terms of the appended claims, the implementations of the present disclosure include many changes, modifications and equivalents.

Features that are described and/or shown with respect to one implementation can be used in the same way or in a similar way in one or more other implementations, can be combined with or replace features in the other implementations.

It should be emphasized that the term “comprise/include” when being used herein refers to the presence of a feature, a whole piece, a step or a component, but does not exclude the presence or addition of one or more other features, whole pieces, steps or components.

### BRIEF DESCRIPTION OF DRAWINGS

An element and a feature described in a drawing or an implementation of the present embodiments of the present disclosure can be combined with an element and a feature shown in one or more other drawings or implementations. In addition, in the drawings, similar labels represent corresponding components in several drawings and may be used to indicate corresponding components used in more than one implementation.

FIG. 1 is a schematic diagram of a communication system in the embodiments of the present disclosure;

FIG. 2 is an exemplary diagram of HARQ-ACK retransmission in NR—U;

FIG. 3 is an exemplary diagram of Mode 1 resource allocation in NR V2X;

FIG. 4 is a schematic diagram of a method for transmitting sidelink feedback information in the embodiments of the present disclosure;

FIG. 5 is an exemplary diagram of sidelink feedback information in the embodiments of the present disclosure;

FIG. 6 is another exemplary diagram of sidelink feedback information in the embodiments of the present disclosure;

FIG. 7 is another schematic diagram of a method for transmitting sidelink feedback information in the embodiments of the present disclosure;

FIG. 8 is another exemplary diagram of sidelink feedback information in the embodiments of the present disclosure;

FIG. 9 is another exemplary diagram of sidelink feedback information in the embodiments of the present disclosure;

FIG. 10 is a schematic diagram of an apparatus for transmitting sidelink feedback information in the embodiments of the present disclosure;

FIG. 11 is another schematic diagram of an apparatus for transmitting sidelink feedback information in the embodiments of the present disclosure;

FIG. 12 is a schematic diagram of a network device in the embodiments of the present disclosure;

FIG. 13 is a schematic diagram of a terminal equipment in the embodiments of the present disclosure.

### DETAILED DESCRIPTION

Referring to the drawings, through the following Specification, the above and other features of the present disclosure will become obvious. The Specification and the figures specifically disclose particular implementations of the present disclosure, showing partial implementations which can adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as Long Term Evolution (LTE), LTE-Advanced (LTE-A), Wideband Code Division Multiple Access (WCDMA), High-Speed Packet Access (HSPA) and so on.

And, communication between devices in a communication system can be carried out according to a communication protocol at any stage, for example may include but be not limited to the following communication protocols: 1G (generation), 2G, 2.5G, 2.75G, 3G, 4G, 4.5G, 5G, New Radio (NR) and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC) and so on.

The base station may include but be not limited to: node B (NodeB or NB), evolution node B (eNodeB or eNB) and a 5G base station (gNB), etc., and may further includes Remote Radio Head (RRH), Remote Radio Unit (RRU), a relay or a low power node (such as femeto, pico, etc.). And the term “BS” may include their some or all functions, each BS may provide communication coverage to a specific geographic region. The term “a cell” may refer to a BS and/or its coverage area, which depends on the context in which this term is used.

In the embodiments of the present disclosure, the term “User Equipment (UE)” or “Terminal Equipment (TE) or Terminal Device” refers to, for example, a device that accesses a communication network and receives network services through a network device. The terminal equipment can be fixed or mobile, and can also be referred to as Mobile Station (MS), a terminal, Subscriber Station (SS), Access Terminal (AT) and a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera and so on.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal and so on.

Moreover, the term “a network side” or “a network device side” refers to a side of a network, may be a base station, and may include one or more network devices as described above. The term “a user side” or “a terminal side” or “a terminal equipment side” refers to a side of a user or terminal, may be a UE, and may include one or more terminal equipment as described above. If it is not specifically mentioned herein, “a device” may refer to a network device, or may refer to a terminal equipment.

The scenarios of the embodiments of the present disclosure are described through the following examples, however the present disclosure is not limited to these.

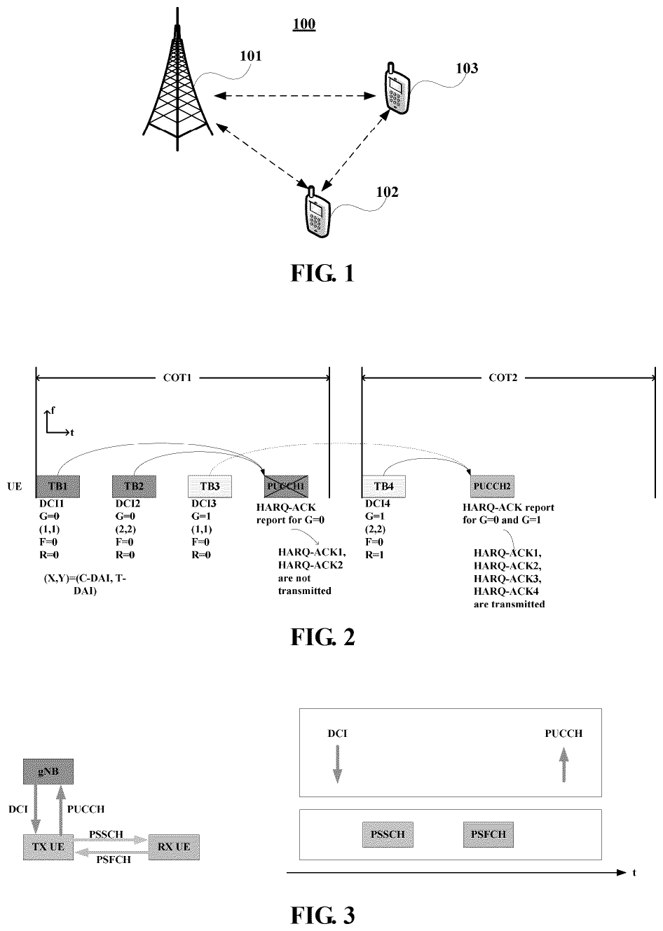

FIG. 1 is a schematic diagram of a communication system in the embodiments of the present disclosure, schematically describes situations by taking a terminal equipment and a network device as examples, as shown in FIG. 1, a communication system 100 may include a network device 101 and terminal equipments 102, 103. For simplicity, FIG. 1 only takes two terminal equipments and one network device as examples for description, however the embodiments of the present disclosure are not limited to these.

In the embodiments of the present disclosure, transmission of existing or further implementable services can be carried out between the network device 101 and the terminal equipments 102, 103. For example, these services may include but be not limited to: enhanced Mobile Broadband (eMBB), massive Machine Type Communication (mMTC), Ultra-Reliable and Low-Latency Communication (URLLC) and so on.

It is worth noting that FIG. 1 shows that two terminal equipments 102 and 103 are within the coverage of network device 101, but the present disclosure is not limited to this. The two terminal equipments 102 and 103 may be outside the coverage of the network device 101, or one terminal equipment 102 may be within the coverage of the network device 101 and the other terminal equipment 103 may be outside the coverage of the network device 101.

In the embodiments of the present disclosure, sidelink transmission can be performed between the two terminal equipments 102 and 103. For example, the two terminal equipments 102 and 103 can both transmit a sidelink within the coverage of the network device 101 to achieve V2X communication, or they can both transmit a sidelink outside the coverage of the network device 101 to achieve V2X communication, it is also possible for one terminal equipment 102 to be within the coverage of the network device 101 and the other terminal equipment 103 to be outside the coverage of the network device 101 to transmit a sidelink to achieve V2X communication.

In order not to affect other wireless access technologies co-existing with it, use of unlicensed frequency bands needs to comply with relevant regulations, which specify transmission power, occupied bandwidth, Channel Occupancy Time (COT), channel access mechanism, etc.

By taking the channel access mechanism as an example, LBT (Listen Before Talk) is an important way when using unlicensed frequency bands. For NR—U, a device (base station or terminal device) may only perform transmission using an unlicensed frequency band when LBT is successful. If the LBT fails, the device cannot perform transmission using the unlicensed frequency band. An LBT failure will have an impact on some traditional processes of NR Uu, such as NR's HARQ feedback process. More specifically, the LBT failure may result in the device not feeding back HARQ-ACK to a base station, or the device not feeding back HARQ-ACK to the base station because a HARQ-ACK feedback moment cannot be located within a current COT.

The NR—U enhances the HARQ process, one of enhancements is introduction of an enhanced Type-2 HARQ-ACK codebook, thereby supporting grouping of an original Type-2 HARQ-ACK codebook and retransmission of HARQ-ACK bits. For the details of the enhanced Type-2 HARQ-ACK codebook, section 9.1.3.3 of the Standard TS 38.213 may be referred to.

FIG. 2 is an exemplary diagram of HARQ-ACK retransmission in NR—U, illustrating the HARQ-ACK retransmission in the NR—U. For the sake of simplicity, a carrier (or cell) is taken as an example for illustration, which can be easily extended to a carrier aggregation scenario. DCI contains a “PDSCH group index” field (G), a DAI field (C-DAI/T-DAI), a “new feedback indicator” field (F), and a “number of requested PDSCH group(s)” field (R). G indicates which group a current PDSCH and an associated HARQ-ACK belong to, there are two groups for selection; DAI is counted within one group, the counting method is the same as the traditional Type-2 HARQ-ACK codebook; F indicates whether to empty previous HARQ-ACK and DAI of this group, and F value flipping indicates EMPTY; R indicates feeding back HARQ-ACK for which group, R=0 indicates feeding back HARQ-ACK of a group scheduled by current DCI, R=1 indicates feeding back HARQ-ACK of two groups.

As shown by FIG. 2, the base station transmits a PDSCH to the device, within COT1, schedules TB 1 using DCI 1 and schedules TB 2 using DCI 2, and indicates the device to feed back the HARQ-ACK codebook containing HARQ-ACK 1 and HARQ-ACK 2 on PUCCH 1. The base station schedules TB 3 using DCI 3. Considering that the device has no time to feed back HARQ-ACK3 in the current COT1, thus the base station indicates that the device does not feed back HARQ-ACK3 temporarily, by indicating a non-numeric value in the “HARQ feedback timing” field. The base station can achieve the above purpose by grouping (G).

The device does not transmit HARQ-ACK 1 and HARQ-ACK 2 on PUCCH 1 due to the LBT failure. So far, the base station does not receive HARQ-ACK 1 to HARQ-ACK 3 within COT 1. However, after that, the base station can schedule the device to retransmit HARQ-ACK 1 to HARQ-ACK 3.

The base station schedules TB 4 using DCI 4 within COT 2, and indicates the device to feed back HARQ-ACKs for two groups, i.e. feed back HARQ-ACK 1 to HARQ-ACK 4. Although the device does not have a chance to transmit HARQ-ACK 1 to HARQ-ACK 3 before, when scheduling the device to feed back HARQ-ACK 4, the base station also schedules the device to retransmit HARQ-ACK 1 to HARQ-ACK 3, thus implementing HARQ-ACK retransmission.

On the other hand, NR V2X defines two operation modes, i.e., Mode 1 and Mode 2. FIG. 3 is an exemplary diagram of Mode 1 resource allocation in NR V2X, illustrating the Mode 1 resource allocation mode. As shown in FIG. 3, the network device (gNB) allocates resources using DCI to the transmitting device (TX UE). TX UE transmits PSCCH/PSSCH to the receiving device (RX UE) on the allocated resources and receives a PSFCH of carrying sidelink HARQ-ACK transmitted by RX UE. TX UE transmits the sidelink HARQ-ACK to the gNB via PUCCH. DCI and PUCCH are transmitted via a Uu interface, PSSCH and PSFCH are transmitted via a sidelink PC5 interface. According to the Standard, if the TX UE does not receive the PSFCH, NACK is fed back to gNB.

3GPP is currently discussing items of Release 18, wherein SL-U (Sidelink-Unlicensed) is one of candidate items. SL-U performs sidelink communication using unlicensed frequency bands, that is, communication between a device and a device. SL-U may further reduce time delay through direct communication between devices, similarly, SL-U may also improve a data rate and reliability of sidelink transmission through using of an additional spectrum. The interested application scenarios include Network Controlled Interactive Service (NCIS), Industrial Internet of Things (IIoT), Internet of Vehicles, smart home, etc.

Currently, 3GPP mainly discusses the necessity of SL-U items and possible research contents, and does not involve any technical details. As described above, the existing standards support Uu interface-based communication over unlicensed frequency bands, i.e. communication between a base station and a device. In addition, 3GPP standardizes sidelink communication using licensed frequency bands.

However, the technical details of SL-U which performs sidelink communication using unlicensed frequency bands have not been discussed by 3GPP. For the SL-U, HARQ-ACK retransmission is also one of the necessary functions. How to support HARQ-ACK retransmission in the SL-U is still an open problem. Complexity is more reflected in Mode 1 resource allocation of a sidelink, wherein TX UE may need to retransmit sidelink HARQ-ACK to the base station, but also needs to request or trigger RX UE to retransmit the sidelink HARQ-ACK to TX UE, which all require a new method to achieve the above double HARQ-ACK retransmission. The existing HARQ-ACK retransmission method cannot be directly applied to SL-U.

In the following description, without causing confusion, the terms “sidelink” and “V2X” are interchangeable, the terms “PSFCH” and “sidelink feedback channel” are interchangeable, the terms “PSCCH” and “sidelink control channel” or “sidelink control information” are interchangeable, the terms “PSSCH” and “sidelink data channel” or “sidelink data” are also interchangeable.

Moreover, transmitting or receiving a PSCCH can be understood as transmitting or receiving sidelink control information carried by the PSCCH; transmitting or receiving a PSSCH can be understood as transmitting or receiving sidelink data carried by the PSSCH; transmitting or receiving a PSFCH can be understood as transmitting or receiving sidelink feedback information carried by the PSFCH. Sidelink transmission (also called sidelink sending) can be understood as PSCCH/PSSCH transmission or sidelink data/information transmission.

In the embodiments of the present disclosure, the first device refers to a transmitting device of a sidelink, and the second device refers to a receiving device of the sidelink, the HARQ-ACK retransmission refers to retransmission of a HARQ-ACK bit, the HARQ-ACK refers to HARQ-ACK for PSCCH/PSSCH, the PSCCH/PSSCH is also abbreviated as PSSCH, and the SCI may refer to 1st stage SCI and/or 2nd stage SCI.

In the embodiments of the present disclosure, the first device receives a sidelink HARQ-ACK (one or more HARQ-ACK bits) from the second device and determines feedback information (such as HARQ-ACK) transmitted to the network device (base station) via the PUCCH based on the sidelink HARQ-ACK from the second device. The process for determining the feedback information transmitted to the network device (base station) can follow the existing standards and can refer to section 16.5 of TS 38.213. In the embodiments of the present disclosure, “feedback information needing to be carried by the PUCCH is not received by the first device” refers to “associated sidelink HARQ-ACK from the second device is not received by the first device”.

### Embodiments of a First Aspect

The embodiments of the present disclosure provide a method for transmitting and receiving sidelink feedback information, illustrated from a first device and a network device.

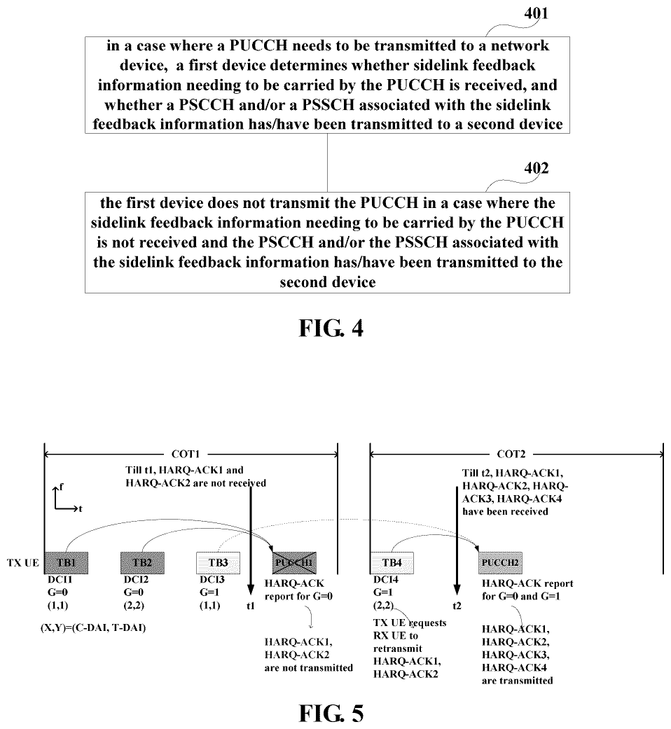

FIG. 4 is a schematic diagram of a method for transmitting sidelink feedback information in the embodiments of the present disclosure, as shown in FIG. 4, the method includes:
401, in a case where a physical uplink control channel (PUCCH) needs to be transmitted to a network device, a first device determines whether sidelink feedback information needing to be carried by the physical uplink control channel is received, and whether a physical sidelink control channel (PSCCH) and/or a physical sidelink shared channel (PSSCH) associated with the sidelink feedback information has/have been transmitted to a second device; and
402, the first device does not transmit the physical uplink control channel (PUCCH) in a case where the sidelink feedback information needing to be carried by the physical uplink control channel is not received and the physical sidelink control channel (PSCCH) and/or the physical sidelink shared channel (PSSCH) associated with the sidelink feedback information has/have been transmitted to the second device.

It should be noted that the above FIG. 4 is only schematic description of the embodiments of the present disclosure, but the present disclosure is not limited to this. For example, an execution step of each operation can be adjusted appropriately, moreover other some operations can be increased or reduced. Persons skilled in the art can make appropriate modifications according to the above contents, not limited to the records in the above FIG. 4.

In some embodiments, a first device transmits a physical sidelink control channel (PSCCH) and/or physical sidelink shared channel (PSSCH) to a second device.

In some embodiments, the first device does not transmit the physical uplink control channel (PUCCH) in a case where all sidelink feedback information needing to be carried by the physical uplink control channel is not received and the physical sidelink control channel (PSCCH) and/or the physical sidelink shared channel (PSSCH) associated with all the sidelink feedback information has/have been transmitted to the second device.

In some embodiments, the first device does not transmit the physical uplink control channel (PUCCH) in a case where the number or a proportion of a plurality of sidelink feedback information needing to be carried by the physical uplink control channel that is not received is greater than a configured or preconfigured threshold and the physical sidelink control channel (PSCCH) and/or the physical sidelink shared channel (PSSCH) associated with the plurality of sidelink feedback information has/have been transmitted to the second device.

In some embodiments, the first device determines whether sidelink feedback information needing to be carried by the physical uplink control channel is valid or whether it is a filling bit in a case where the first device needs to transmit the physical uplink control channel (PUCCH) to a network device; the first device does not transmit the physical uplink control channel (PUCCH) in a case where the sidelink feedback information needing to be carried by the physical uplink control channel is invalid or is a filling bit.

In some embodiments, the first device determines that the sidelink feedback information is invalid or is a filling bit in a case where the sidelink feedback information is not received and the physical sidelink control channel (PSCCH) and/or the physical sidelink shared channel (PSSCH) associated with the sidelink feedback information has/have been transmitted to the second device.

In some embodiments, the first device does not transmit the physical uplink control channel (PUCCH) in a case where all sidelink feedback information needing to be carried by the physical uplink control channel are invalid or are filling bits.

In some embodiments, the first device does not transmit the physical uplink control channel (PUCCH) in a case where the number or a proportion of invalid sidelink feedback information in a plurality of sidelink feedback information needing to be carried by the physical uplink control channel or the number or a proportion of filling bits is greater than a configured or preconfigured threshold.

FIG. 5 is an exemplary diagram of sidelink feedback information in the embodiments of the present disclosure. As shown in FIG. 5, the network device (base station) allocates a resource for transmitting the PSSCH to the device 1 (first device or transmitting device) using DCI and indicates a PUCCH resource for transmitting sidelink HARQ-ACK. The PSSCH resource is located in an unlicensed frequency band, the DCI may be transmitted using an unlicensed frequency band or licensed frequency band, and PUCCH may be transmitted using an unlicensed frequency band or licensed frequency band.

The following is described from the perspective of a base station. DCI1 and DCI2 indicate group 0 (G=0) and C-DAI and T-DAI counted in the group 0, and instruct device 1 to feed back HARQ-ACK for the group 0 on PUCCH1, i.e. HARQ-ACK1 and HARQ-ACK2. DCI3 indicates group 1 (G=1) and C-DAI and T-DAI counted within the group 1. Taking into account that device 1 has no time to feed back HARQ-ACK3 for DCI3 (or TB3) within COT1 (or on PUCCH1), DCI3 instructs device 1 not to feed back HARQ-ACK3 temporarily.

The following is described from the perspective of the device 1. Device 1 transmits TB1 and TB2 over resources allocated by DCI1 and DCI2. In order to transmit HARQ-ACK1 and HARQ-ACK2 for TB1 and TB2 to a base station on PUCCH1, device 1 needs to obtain HARQ-ACK1 and HARQ-ACK2 from device 2 (second device or receiving device) before time t1. However, as of t1, device 1 may not receive HARQ-ACK1 and HARQ-ACK2. In this circumstance, device 1 does not transmit PUCCH1. Therefore, the base station will not receive HARQ-ACK1 and HARQ-ACK2 on PUCCH1, thereby the base station may choose a next COT (COT2) scheduling device 1 to retransmit HARQ-ACK1 and HARQ-ACK2 (retransmitted to the base station), instead of scheduling device 1 to retransmit TB1 and TB2 (retransmitted to device 2). For example, the base station uses DCI4 to allocate a resource for transmitting TB4 to device 1, at the same time, DCI4 indicates device 1 to feed back HARQ-ACK for group 0 and group 1 on PUCCH2, that is, HARQ-ACK1 to HARQ-ACK4, thereby realizing retransmission of HARQ-ACK1 and HARQ-ACK2. To obtain HARQ-ACK1 and HARQ-ACK2, device 1 does not retransmit TB1 and TB2, but indicates device 2 to retransmit HARQ-ACK1 and HARQ-ACK2. For example, device 1 indicates device 2 to retransmit HARQ-ACK using a method similar to that used by a base station to schedule device 1 to retransmit HARQ-ACK. After receiving DCI4, device 1 indicates device 2 to retransmit HARQ-ACK1 and HARQ-ACK2 by using SCI. Device 1 indicates G, SAI and other parameters in SCI. The parameters may be determined independently and may be the same or different from parameters indicated by DCI of the base station. TB1 and TB2 are not retransmitted, thus occupation of an unlicensed frequency band is reduced, and interference with other devices using an unlicensed frequency band is avoided. Moreover, when PUCCH is located in an unlicensed frequency band, not transmitting PUCCH1 by device 1 can also reduce the occupation of the unlicensed frequency band and avoid interference with other devices using the unlicensed frequency band.

For the sake of simplicity, FIG. 5 only shows a “group index” field (G) and a DAI field (C-DAI/T-DAI) in DCI. In order to realize a HARQ-ACK retransmission function, the DCI may also contain other fields, such as a “new feedback indicator” field, a “number of requested group(s)” field, etc., usage of these omitted fields is the same as usage in the existing NR—U standards.

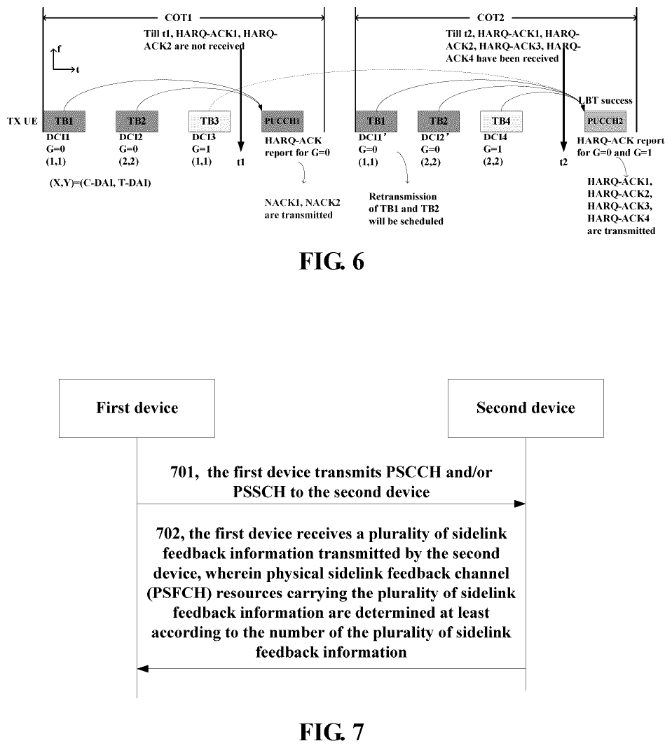

FIG. 6 is another exemplary diagram of sidelink feedback information in the embodiments of the present disclosure, showing a situation if an existing scheme continues to be used. As shown in FIG. 6, device 1 will transmit NACK1 and NACK2 to the base station without receiving HARQ-ACK1 and HARQ-ACK2, that is, filled with NACK. After receiving NACK1 and NACK2, the base station will consider that the device fails in demodulation decoding, thereby continues to schedule device 1 to retransmit TB1 and TB2, but will not schedule device 1 to retransmit HARQ-ACK1 and HARQ-ACK2. Retransmission of TB1 and TB2 additionally occupies unlicensed frequency bands, reduces resource utilization, and may cause interference to other devices.

Therefore, compared to transmitting the NACK on PUCCH1, not transmitting PUCCH1 actually corresponds to transferring additional state information that is different from ACK and NACK to the base station. Based on this information, the base station may only schedule HARQ-ACK retransmission, but not schedule PSSCH retransmission, which can reduce occupation of unauthorized frequency bands.

FIG. 5 describes illustratively by taking an example that PUCCH1 contains HARQ-ACK1 and HARQ-ACK2. In fact, PUCCH1 may contain only one HARQ-ACK or may contain more HARQ-ACKs, the embodiments of the present disclosure are not limited to this.

The embodiments of the present disclosure do not limit reasons why device 1 does not receive HARQ-ACK (such as HARQ-ACK 1 and HARQ-ACK 2). For example, device 2 does not transmit HARQ-ACK to device 1 due to an LBT failure. For another example, device 2 needs to simultaneously transmit or receive other signals with higher priority, device 2 does not transmit HARQ-ACK to device 1 based on a precedence rule. For another example, although device 2 transmits HARQ-ACK to device 1, device 1 needs to simultaneously transmit other signals with higher priority, and based on a precedence rule, device 1 does not receive the HARQ-ACK transmitted by device 2.

When PUCCH is located in an unlicensed frequency band, not transmitting PUCCH1 by device 1 may include the following actions. For example, device 1 does not perform LBT for PUCCH1. For another example, device 1 successfully performs LBT for PUCCH1, but device 1 still does not transmit PUCCH1.

In some embodiments, a first device transmits non-acknowledgment (NACK) information to a network device in a case where PSCCH and/or PSSCH are/is not transmitted to a second device due to an LBT failure.

As an implementation, for situations other than those described above in which the first device does not receive HARQ-ACK, the first device transmits NACK to the base station.

As an implementation, the first device transmits NACK to the base station in a case where the first device does not transmit a PSSCH due to an LBT failure.

For example, the first device does not transmit a PSSCH to the second device due to an LBT failure, which includes not transmitting the PSSCH on a resource that is scheduled by DCI, and also includes not transmitting the PSSCH on a resource with configured grant. At this case, the first device will not receive HARQ-ACK from the second device. In this situation, the first device transmits NACK to the base station. After receiving the NACK, the base station will continue to allocate resources to the first device, and the first device may continue to transmit PSSCH on the allocated resources.

As an implementation, for situations other than those described above in which the first device does not receive HARQ-ACK, when the number or proportion of unreceived HARQ-ACKs is greater than a certain threshold, the first device does not transmit a PUCCH; otherwise, the first device fills the unreceived HARQ-ACKs as NACKs.

For example, among all HARQ-ACK bits carried by the PUCCH, if the first device only receives a part of the HARQ-ACK bits, in a case where the number of unreceived HARQ-ACK bits is greater than a certain threshold, or, in a case where a proportion of unreceived HARQ-ACK bits to all HARQ-ACK bits is greater than a certain threshold, the first device does not transmit the PUCCH; otherwise, the first device fills the unreceived HARQ-ACKs as NACKs. “Greater than” here may also be replaced with “greater than or equal to”. The threshold may be configured or pre-configured.

In some embodiments, a network device transmits information instructing to retransmit the sidelink feedback information in a case where the physical uplink control channel is not received. The first device receives the information instructing to retransmit the sidelink feedback information and may trigger retransmission of the sidelink feedback information.

In some embodiments, a first device is enabled to retransmit the sidelink feedback information to the network device, and the second device is enabled to retransmit the sidelink feedback information to the first device.

That is, optionally, the following conditions must be met for a behavior in which the first device does not transmit a PUCCH: the first device is enabled that a function of retransmitting a HARQ-ACK to a base station, and the second device is enabled that the function of retransmitting the HARQ-ACK to the first device.

A device needs to have certain capability to support the retransmission of HARQ-ACK bits. For example, device 1 in FIG. 5 needs to have a capability to store HARQ-ACK3 temporarily and retransmitting HARQ-ACK3 at some moment in the future. For another example, in FIG. 5, device 1 will further instruct device 2 to retransmit HARQ-ACK1 and HARQ-ACK2 after receiving DCI4, so device 2 needs to have a capability to store results of HARQ-ACK1 and HARQ-ACK2 until this time.

Equivalently, the capability to support HARQ-ACK retransmission may also be called a capability to support an enhanced HARQ-ACK codebook. For example, as shown in FIG. 5, a retransmitted HARQ-ACK bit is transmitted to the base station in the form of a HARQ-ACK codebook. Without causing confusion, it is also referred to as a capability.

The capability to support HARQ-ACK retransmission may be interacted between a device and a device and/or between a device and a base station, so that the base station enables the first device to perform HARQ-ACK retransmission via a configuration, and/or the first device enables the second device to perform HARQ-ACK retransmission via a configuration.

In some embodiments, the first device transmits capability information of whether the first device is capable of supporting sidelink feedback information retransmission and/or capability information of whether the second device is capable of supporting sidelink feedback information retransmission to the network device.

In some embodiments, the first device receives instruction information transmitted by the network device and used for enabling the first device to perform sidelink feedback information retransmission.

In some embodiments, the first device receives capability information of whether the second device is capable of supporting sidelink feedback information retransmission transmitted by the second device.

In some embodiments, the first device transmits instruction information used for enabling the second device to perform sidelink feedback information retransmission to the second device.

For example, capability interaction and reporting include an instruction on whether a device is capable of supporting HARQ-ACK retransmission. There is no restriction on a specific mode in which HARQ-ACK retransmission is enabled via a configuration (or via instruction information). For example, when a device is configured with a parameter HARQ-ACK-Codebook and a value of the parameter is configured to be “enhanced”, it represents that HARQ-ACK retransmission is enabled on the device.

Interaction of HARQ-ACK retransmission capabilities includes at least one of the following ways.
The second device reports a capability to the first device.
The first device reports the capability to a base station.

Enabling of the HARQ-ACK retransmission function includes at least one of the following ways.
The base station enables HARQ-ACK retransmission of the first device.
The first device enables HARQ-ACK retransmission of the second device.

The embodiments of the present disclosure may also include any combination of the above ways.

For example: the second device reports its own capability of supporting HARQ-ACK retransmission to the first device. In a case where both the first device and the second device support HARQ-ACK retransmission, the first device reports to the base station that it is able to support HARQ-ACK retransmission; otherwise, the first device reports to the base station that it cannot support HARQ-ACK retransmission. It is worth noting that the first device here does not directly report its own capability of supporting HARQ-ACK retransmission to the base station. The base station determines whether to enable HARQ-ACK retransmission of the first device. The first device determines whether to enable HARQ-ACK retransmission of the second device. For example, in a case where the base station enables HARQ-ACK retransmission of the first device, the first device enables HARQ-ACK retransmission of the second device.

For another example: the second device reports its own capability of supporting HARQ-ACK retransmission to the first device. The first device reports a capability for the first device of supporting HARQ-ACK retransmission and a capability for the second device of supporting HARQ-ACK retransmission to the base station. The base station determines whether to enable HARQ-ACK retransmission of the first device. The first device determines whether to enable HARQ-ACK retransmission of the second device. For example, in a case where the base station enables HARQ-ACK retransmission of the first device, the first device enables HARQ-ACK retransmission of the second device.

For another example: the second device reports its own capability of supporting HARQ-ACK retransmission to the first device. The first device reports a capability for the first device of supporting HARQ-ACK retransmission to the base station. The base station determines whether to enable HARQ-ACK retransmission of the first device. The first device determines whether to enable HARQ-ACK retransmission of the second device. For example, in a case where the base station enables HARQ-ACK retransmission of the first device, the first device enables HARQ-ACK retransmission of the second device.

The above is a schematic description of a method for transmitting sidelink feedback information from the perspective of the first device, and the following is a schematic description of a method for receiving the sidelink feedback information from the perspective of the network device, and the same contents as the previous embodiments will not be repeated.

In some embodiments, a network device receives sidelink feedback information from the first device and carried by a physical uplink control channel; wherein the physical uplink control channel (PUCCH) is transmitted by the first device in a case where it is determined that the sidelink feedback information needing to be carried by the physical uplink control channel has been received.

In some embodiments, the physical uplink control channel (PUCCH) is not transmitted by the first device in a case where the sidelink feedback information needing to be carried by the physical uplink control channel is not received by the first device, and the first device has transmitted a physical sidelink control channel (PSCCH) and/or a physical sidelink shared channel (PSSCH) associated with the sidelink feedback information to the second device.

In some embodiments, the physical uplink control channel (PUCCH) is not transmitted by the first device in a case where all the sidelink feedback information needing to be carried by the physical uplink control channel is not received by the first device, and the first device has transmitted a physical sidelink control channel (PSCCH) and/or a physical sidelink shared channel (PSSCH) associated with all the sidelink feedback information to the second device.

In some embodiments, the physical uplink control channel (PUCCH) is not transmitted by the first device in a case where the number or a proportion of a plurality of sidelink feedback information needing to be carried by the physical uplink control channel that is not received by the first device is greater than a configured or preconfigured threshold, and the first device has transmitted the physical sidelink control channel (PSCCH) and/or the physical sidelink shared channel (PSSCH) associated with the plurality of sidelink feedback information to the second device.

In some embodiments, a network device transmits information instructing to retransmit the sidelink feedback information to the first device in a case where the physical uplink control channel is not received.

In some embodiments, a first device is enabled to retransmit the sidelink feedback information to a network device, and a second device is enabled to retransmit the sidelink feedback information to the first device.

In some embodiments, the network device receives capability information of whether the first device is capable of supporting sidelink feedback information retransmission and/or capability information of whether the second device is capable of supporting sidelink feedback information retransmission as transmitted by the first device.

In some embodiments, the network device transmits instruction information used for enabling the first device to perform sidelink feedback information retransmission to the first device.

The above mainly describes HARQ-ACK interaction between the first device and the network device, and does not restrict how a HARQ-ACK interact between the first device and the second device.

Each of the above embodiments is only illustrative for the embodiments of the present disclosure, but the present disclosure is not limited to this, appropriate modifications can be also made based on the above each embodiment. For example, each of the above embodiments may be used individually, or one or more of the above embodiments may be combined.

As can be known from the above embodiments, for HARQ-ACK retransmission from a first device to a network device, if the first device has transmitted a PSCCH and/or PSSCH associated with HARQ-ACK to a second device, but has not received sidelink feedback information needing to be carried by the PUCCH (i.e., the PUCCH does not contain a valid HARQ-ACK bit), the first device does not transmit the PUCCH to the network device, thereby unnecessary occupation of an unlicensed frequency band can be reduced or avoided, and the network device can be notified to schedule HARQ-ACK retransmission.

### Embodiments of a Second Aspect

The embodiments of the present disclosure provide a method for transmitting and receiving sidelink feedback information, illustrated from a first device and a second device. The embodiments of the present disclosure schematically illustrate HARQ-ACK interaction between the first device and the second device, may be combined with the embodiments of the first aspect, or may be implemented separately.

FIG. 7 is a schematic diagram of a method for transmitting sidelink feedback information in the embodiments of the present disclosure, as shown in FIG. 7, the method includes:
701, a first device transmits a physical sidelink control channel (PSCCH) and/or physical sidelink shared channel (PSSCH) to a second device;
702, the first device receives a plurality of sidelink feedback information transmitted by the second device, wherein physical sidelink feedback channel (PSFCH) resources carrying the plurality of sidelink feedback information are determined at least according to the number of the plurality of sidelink feedback information.

It should be noted that the above FIG. 7 is only schematic description of the embodiments of the present disclosure, but the present disclosure is not limited to this. For example, an execution step of each operation can be adjusted appropriately, moreover other some operations can be increased or reduced. Persons skilled in the art can make appropriate modifications according to the above contents, not limited to the records in the above FIG. 7.

The first device transmits a TB to the second device on the PSSCH, and then receives a HARQ-ACK on a PSFCH resource associated with the PSSCH. For a sidelink unlicensed frequency band, in order to meet the requirements of relevant regulations, a physical layer structure of the sidelink physical channel and a physical signal may change. For example, a PSSCH of a traditional sidelink takes a sub-channel as granularity, including continuous sub-channels in several frequency domains, a PSSCH of a sidelink unlicensed frequency band may take interlacing as granularity, including continuous or non-continuous interlacing in several frequency domains.

The embodiments of the present disclosure do not restrict a physical layer structure, but only describe it from a logical resource level. Regardless of a structure of a physical resource, logically, a PSSCH resource will be associated with a PSFCH resource. For example, according to the existing standards, there are R_{PRB,CS}^{PSFCH} candidate PSFCH resources associated with a PSSCH, and among the R_{PRB,CS}^{PSFCH} candidate PSFCH resources, a final index of a PSFCH resource for transmitting HARQ-ACK and associated with the PSSCH is (P_{ID}+M_{ID})mod(R_{PRB,CS}^{PSFCH}), where P_{ID} denotes a physical layer source identifier (physical layer source ID), and for multicast with HARQ Option 2, M_{ID} denotes an identifier configured by a higher layer, which is actually an identifier of a member in a group (group member ID), and for unicast and multicast with HARQ Option 1, M_{ID}=0. For more specific parameter definitions and a method for determining a PSFCH associated with a PSSCH, section 16.3 of the Standard TS 38.213 may be referred to.

In a case where physical layer structures of the PSSCH and the PSFCH change, the above method may be extended adaptively, for example, a sub-channel of the PSSCH is replaced with interlacing of the PSSCH, and only using one RB by the PSFCH is extended to use a plurality of RBs. In short, R_{PRB,CS}^{PSFCH} candidate PSFCH resources associated with a PSSCH are determined according to the above method or an extension method. In a case where a second device needs to transmit more than one HARQ-ACK bit, a final index of the PSFCH resource for transmitting a plurality of HARQ-ACK bits and associated with the PSSCH cannot be determined by using the formula (P_{ID}+M_{ID})mod(R_{PRB,CS}^{PSFCH}) in the existing methods.

The following describes a situation in which the second device needs to transmit more than one HARQ-ACK bit.

In some cases, the first device transmits one PSSCH, but instructs the second device to feed back more than one HARQ-ACK bit. For example, in FIG. 5, the first device transmits TB4 on the PSSCH while instructing the second device in the SCI to feed back four HARQ-ACK bits including HARQ-ACK retransmission. For another example, the first device transmits PSSCH1 (TB1), but an associated PSFCH slot is outside of a current COT, so the first device instructs the second device in the SCI not to feed back HARQ-ACK for the time being, or the second device makes its own judgment not to feed back HARQ-ACK for the time being based on the fact that the PSFCH slot is outside of the COT. Then, when the first device transmits PSSCH2 (TB2), SCI is used to instruct the second device to feed back a plurality of HARQ-ACK bits including HARQ-ACK1 for TB1 and HARQ-ACK2 for TB2.

In order to be able to transmit a plurality of HARQ-ACK bits including HARQ-ACK retransmission, a plurality of PSFCH resources need to be determined based on one PSSCH, but related arts may only determine one PSFCH resource based on one PSSCH. For this problem, in the embodiments of the present disclosure, physical sidelink feedback channel (PSFCH) resources carrying the plurality of sidelink feedback information are determined at least according to the number of the plurality of sidelink feedback information.

For example, the physical sidelink feedback channel (PSFCH) resources are determined by the following formula:

$$( {P}_{ID} + {M}_{ID} \cdot Q + q ) mod ( {R}_{PRB , CS}^{PSFCH} )$$

where, P_{ID} denotes a physical layer source identifier (physical layer source ID), M_{ID} denotes an identifier of a member in a group (group member ID) configured by a higher layer, Q denotes the number of the plurality of sidelink feedback information, and q=0,1, . . . , Q−1.

For example, for multicast with HARQ Option 2, M_{ID} denotes an identifier configured by a higher layer, which is actually an identifier of a member in a group (group member ID). For unicast, M_{ID}=0. For multicast with HARQ Option 1, M_{ID}=0.

In some embodiments, the number of the plurality of sidelink feedback information is determined based on an Assignment Index (AI) field in sidelink control information transmitted by the first device to the second device, the Assignment Index for example is called SAI.

For example, a value of Q may be obtained based on signaling transmitted by the first device to the second device. For example, it is obtained based on a C-SAI/T-SAI field in the 2nd stage SCI.

In some embodiments, a plurality of sidelink feedback information include: feedback information for a currently-scheduled physical sidelink control channel (PSCCH) and/or physical sidelink shared channel (PSSCH), and/or, feedback information for a previously-scheduled physical sidelink control channel (PSCCH) and/or physical sidelink shared channel (PSSCH).

For example, Q HARQ-ACK bits include: HARQ-ACK bits for a currently-scheduled PSSCH, and/or HARQ-ACK bits for a previously-scheduled PSSCH.

In some embodiments, transport blocks (TB) carried by the currently-scheduled physical sidelink control channel (PSCCH) and/or physical sidelink shared channel (PSSCH) are different from transport blocks (TB) carried by the previously-scheduled physical sidelink control channel (PSCCH) and/or physical sidelink shared channel (PSSCH).

By taking multicast with HARQ Option 2 as an example, it is assumed that the first device transmits the PSSCH in a multicast mode and instructs the second device (a member device) to transmit Q HARQ-ACK bits. For multicast, one first device corresponds to a plurality of second devices. Q HARQ-ACK bits include: HARQ-ACK bits for the PSSCH, and HARQ-ACK bits for retransmission of a previous PSSCH. Member device 0 has M_{ID}=0, member device 1 has M_{ID}=1, member device 2 has M_{ID}=2, and so on.

According to the above method, in order to transmit Q HARQ-ACK bits, each member device transmits Q PSFCHs, and each PSFCH carries 1-bit HARQ-ACK according to an existing mode. A PSFCH resource used by member device 0 is (P_{ID}+q)mod(R_{PRB,CS}^{PSFCH}), q=0,1, . . . , Q−1; a PSFCH resource used by member device 1 is (P_{ID}+Q+q)mod(R_{PRB,CS}^{PSFCH}), q=0,1, . . . , Q−1; a PSFCH resource used by member device 2 is (P_{ID}+2Q+q)mod(R_{PRB,CS}^{PSFCH}), q=0,1, . . . , Q−1; and so on. Through the embodiments of the present disclosure, PSFCH resources of different member devices are different from each other.

On the contrary, if a resource for transmitting a PSFCH in an existing method is (P_{ID}+q)mod(R_{PRB,CS}^{PSFCH}), a resource for transmitting Q PSFCHs is determined to be (P_{ID}+M_{ID}+q)mod(R_{PRB,CS}^{PSFCH}), on this basis, a PSFCH resource used by member device 0 is (P_{ID}+q)mod(R_{PRB,CS}^{PSFCH}), q=0,1, . . . , Q−1; a PSFCH resource used by member device 1 is (P_{ID}+1+q)mod(R_{PRB,CS}^{PSFCH}), q=0,1, . . . , Q−1; a PSFCH resource used by member device 2 is (P_{ID}+2+q)mod(R_{PRB,CS}^{PSFCH}), q=0,1, . . . , Q−1; and so on. Thus, it can be seen that different member devices will transmit a HARQ-ACK using the same PSFCH resource, making it impossible for the first device to distinguish a received HARQ-ACK comes from which second device, thereby resulting in confusion. For example, assuming Q=3, when q=2, member device 0 uses PSFCH resource (P_{ID}+2)mod(R_{PRB,CS}^{PSFCH}), when q=1, member device 1 uses PSFCH resource (P_{ID}+2)mod(R_{PRB,CS}^{PSFCH}), when q=0, member device 2 uses the PSFCH resource (P_{ID}+2)mod(R_{PRB,CS}^{PSFCH}), and a plurality of member devices use the same PSFCH resource.

The above method for transmitting Q HARQ-ACK bits by the devices actually is not limited to this application scenario for an unlicensed frequency band of a sidelink. The same method may also be extended to other scenarios. For example, the above method may be applied to a carrier aggregation (CA) scenario. The first device transmits a plurality of PSSCHs on a plurality of carriers to the second device by using a cross-carrier scheduling mode or a self-scheduling mode, and the second device simultaneously transmits a plurality of HARQ-ACK bits on a cell (such as Pcell) to the first device.

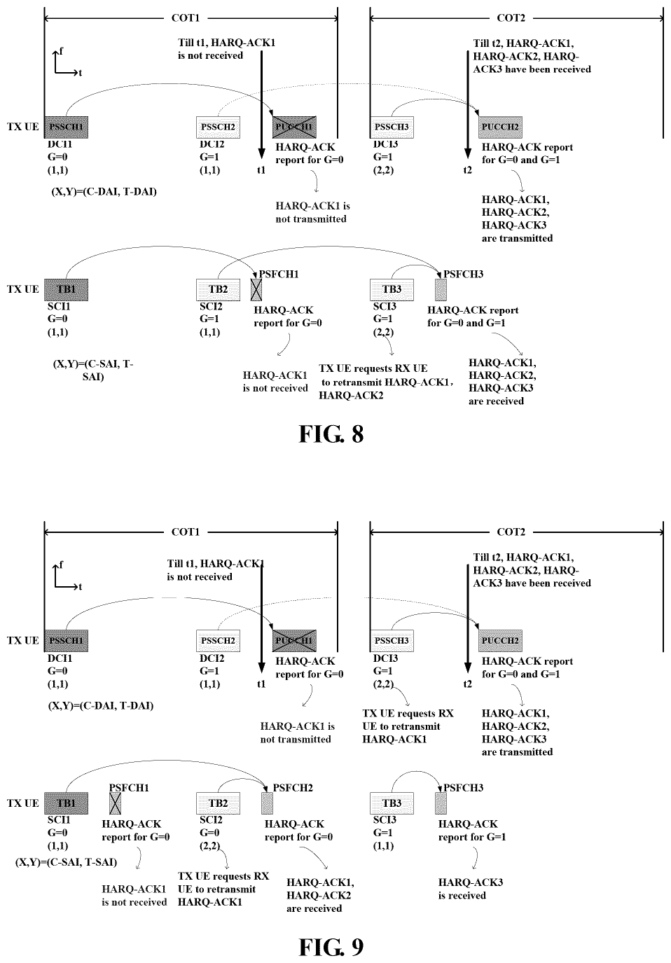

FIG. 8 is another exemplary diagram of sidelink feedback information in the embodiments of the present disclosure, including a complete receiving and transmitting procedure of a Uu link and a sidelink. The upper half part of FIG. 8 shows a Uu procedure, and the lower half part thereof shows a sidelink procedure.

As shown in FIG. 8, the network device (base station) obtains COT1, schedules the first device to transmit TB1 in COT1 (that is, the base station allocates the resource PSSCH1 to the first device, and the first device determines to transmit TB1 on PSSCH1), and instructs it to feed back HARQ-ACK1 on PUCCH1. Due to a LBT failure of the second device for PSFCH1 (the second device does not transmit PSFCH1), the first device does not receive HARQ-ACK1 for TB1 on PSFCH1, so the first device does not send PUCCH1. The base station schedules the first device to transmit TB2, since HARQ-ACK2 for TB2 has no time to feed back in COT1, the base station instructs the first device not to feed back HARQ-ACK2 for the time being. Since PSFCH2 associated with TB2 is located outside of COT1, the first device instructs the second device in SCI2 not to feed back HARQ-ACK2 for the time being, or the second device determines at its own discretion based on a PSFCH2 slot and a COT1 time length that there is no need to feed back HARQ-ACK2 on the PSFCH2.

The base station obtains COT2, schedules the first device to transmit TB3 in COT2, instructs it to feed back HARQ-ACK for group 0 (G=0) and group 1 (G=1) on PUCCH2, that is, feed back HARQ-ACK1 to HARQ-ACK3. The first device instructs the second device via SCI3 to feed back HARQ-ACK for groups 0 (G=0) and group 1 (G=1) on PSFCH3 associated with TB3, i.e. feed back HARQ-ACK1 to HARQ-ACK3. The first device receives HARQ-ACK1 to HARQ-ACK3 transmitted by the second device on PSFCH3, then transmits HARQ-ACK1 to HARQ-ACK3 to the base station on PUCCH2. PSFCH3 here refers to all PSFCHs associated with the PSSCH carrying TB3, that is, a PSFCH resource carrying Q HARQ-ACK bits from a second device, the previously described method for determining PSFCH resources of Q HARQ-ACK bits may be used. Similar to a method for a Uu to use DCI, a sidelink uses SCI to instruct G, C-SAI/T-SAI, so as to achieve the purpose of scheduling HARQ-ACK retransmission. For example, in FIG. 8, SCI3 instructs the second device to transmit a plurality of HARQ-ACK bits simultaneously, including retransmission of HARQ-ACK1 and HARQ-ACK2.

In some embodiments, information indicating grouping and/or retransmission of the sidelink feedback information in the sidelink control information (SCI) transmitted by the first device to the second device is independent of information indicating grouping and/or retransmission of the sidelink feedback information in downlink control information (DCI) transmitted by the network device to the first device.

FIG. 9 is another exemplary diagram of sidelink feedback information in the embodiments of the present disclosure, including a complete receiving and transmitting procedure of a Uu link and a sidelink. A difference from FIG. 8 is that due to different PSFCH resources contained in the COT, values of G, C-SAI/T-SAI instructed by SCI may be different from values of G, C-DAI/T-DAI instructed by DCI.

For the sake of simplicity, FIG. 9 only shows a “group index” field (G), a DAI field (C-DAI/T-DAI) and a SAI field (C-SAI/T-SAI) in DCI and SCI. In order to realize a HARQ-ACK retransmission function, the DCI and the SCI may also contain other fields, such as a “new feedback indicator” field, a “number of requested group(s)” field, etc. Similarly, values of these omitted fields in the SCI may be different from those in the DCI. Due to the LBT failure, the second device does not transmit HARQ-ACK1 on PSFCH1. Thus, the first device does not transmit PUCCH1. Through G and C-SAI/T-SAI instructed by the SCI, the first device instructs the second device to feed back HARQ-ACK1 and HARQ-ACK2 on PSFCH2 associated with TB2.

Here, a plurality of PSFCH resources carrying HARQ-ACK1 and HARQ-ACK2 may be determined using the embodiments of the present disclosure. Although the first device receives HARQ-ACK1 and HARQ-ACK2 in the PSFCH2 slot, it has no time to transmit to the base station on PUCCH1. The first device receives HARQ-ACK3 on PSFCH3, and then transmits HARQ-ACK1 to HARQ-ACK3 to the base station on PUCCH2. As can be seen from FIG. 9, as long as the first device can ensure that HARQ-ACK1 to HARQ-ACK3 are transmitted to the base station on PUCCH2, how to receive HARQ-ACK1 to HARQ-ACK3 through a sidelink can be determined by the first device itself, and there is no need to copy scheduling of HARQ-ACK by the base station in DCI.

The complete receiving and transmitting procedure involved in FIG. 9 may be summarized as follows:
A base station instructs the first device in DCI1 to transmit on PSSCH1 and instructs the first device to feed back HARQ-ACK1 associated with PSSCH1 on PUCCH1.
The first device transmits TB1 on PSSCH1. Since the second device does not transmit HARQ-ACK1 on PSFCH1 associated with PSSCH1 (for example, due to an LBT failure), the first device does not receive HARQ-ACK1 on PSFCH1.
The first device does not transmit PUCCH1 to the base station. Since PUCCH1 is not received, the base station knows that it may look for an opportunity to schedule the first device to retransmit HARQ-ACK1 at a later time.
The base station instructs the first device in DCI2 to transmit on PSSCH2 and instructs the first device not to feed back HARQ-ACK2 for the time being
The first device transmits TB2 on PSSCH2, and instructs the second device in SCI2 to transmit HARQ-ACK1 and HARQ-ACK2 in a PSFCH2 slot, that is, schedule retransmission for HARQ-ACK1. PSFCH2 here may include more than one PSFCH resource, and these PSFCH resources are associated with PSSCH2, that is, one PSSCH is associated with a plurality of PSFCH resources.
The second device determines a plurality of PSFCH resources for transmitting HARQ-ACK1 and HARQ-ACK2 according to (P_{ID}+M_{ID}. Q+q)mod(R_{PRB,CS}^{PSFCH}). Q is determined according to the C-SAI/T-SAI field in SCI2, which is equal to the number of HARQ-ACK bits that need to be transmitted simultaneously by the second device, and which is also equal to a size of a HARQ-ACK codebook. The second device transmits HARQ-ACK1 and HARQ-ACK2 in the PSFCH2 slot.
The first device receives HARQ-ACK1 and HARQ-ACK2 in the PSFCH2 slot.
The base station instructs the first device in DCI3 to transmit on PSSCH3, and instructs the first device to feed back HARQ-ACK1 to HARQ-ACK3 on PUCCH2, that is, schedule retransmission for HARQ-ACK1 and HARQ-ACK2.
The first device transmits TB3 on PSSCH3, and instructs the second device in SCI3 to transmits HARQ-ACK3 in a PSFCH3 slot.
The second device determines PSFCH resources for transmitting HARQ-ACK3 according to (P_{ID}+M_{ID}·Q+q)mod(R_{PRB,CS}^{PSFCH}). According to the C-SAI/T-SAI field in SCI3, here Q=1.
The first device receives HARQ-ACK3 in the PSFCH3 slot.
The first device transmits HARQ-ACK1 to HARQ-ACK3 to the base station on PUCCH2.

In some embodiments, the first device receives information transmitted by the second device, the information indicating the number of PSFCHs that the second device is able to transmit simultaneously.

For example, the second device may notify the first device of the number N of PSFCHs that the second device is able to transmit simultaneously, so that the first device determines the number Q of PSFCHs that the scheduled second device transmit simultaneously. For example, the first device ensures Q≤ N during scheduling. There is no restriction on how the second device determines a value of N. N≤Nₘₐₓ, where Nₘₐₓ denotes the maximum number of PSFCHs that the second device is able to transmit simultaneously, and Nₘₐₓ depends on a device capability. The first device determines the number Q of PSFCHs that the scheduled second device transmit simultaneously, actually also determines a size of a HARQ-ACK codebook transmitted by the second device.

In some embodiments, a plurality of sidelink feedback information is determined as a whole whether to be discarded, and wherein a highest priority in the plurality of sidelink feedback information is used for priority comparison.

For example, the second device may need to transmit a HARQ-ACK codebook to the first device, meanwhile further needs to transmit a HARQ-ACK to a third device. This may cause the number of PSFCHs transmitted simultaneously by the second device to exceed Nₘₐₓ. At this moment, the second device needs to discard some PSFCHs, that is, only transmits part of the PSFCHs. In the existing priority rules, only several PSFCHs with the highest priority are selected for transmission. In the presence of a HARQ-ACK codebook, if only part of HARQ-ACKs in the HARQ-ACK codebook is transmitted, the integrity of the HARQ-ACK codebook will be damaged, so that the first device fails to receive the HARQ-ACK codebook. Therefore, the HARQ-ACK codebook should be determined as a whole whether to be discarded. The priority of the HARQ-ACK codebook is equal to the highest priority in all the HARQ-ACKs included in the HARQ-ACK codebook.

Each of the above embodiments is only illustrative for the embodiments of the present disclosure, but the present disclosure is not limited to this, appropriate modifications can be also made based on the above each embodiment. For example, each of the above embodiments may be used individually, or one or more of the above embodiments may be combined.

As can be known from the above embodiments, for HARQ-ACK retransmission from the second device to the first device, a size of a HARQ-ACK codebook is additionally used to determine a PSFCH resource, so as to avoid a PSFCH resource collision during HARQ-ACK retransmission of multicast.

### Embodiments of a Third Aspect

The embodiments of the present disclosure provide an apparatus for transmitting sidelink feedback information. The apparatus e.g. may be a terminal equipment (such as the above mentioned first device), or it may be one or more parts or components configured on the terminal equipment. The contents same as the embodiments of the first and second aspects are not repeated.

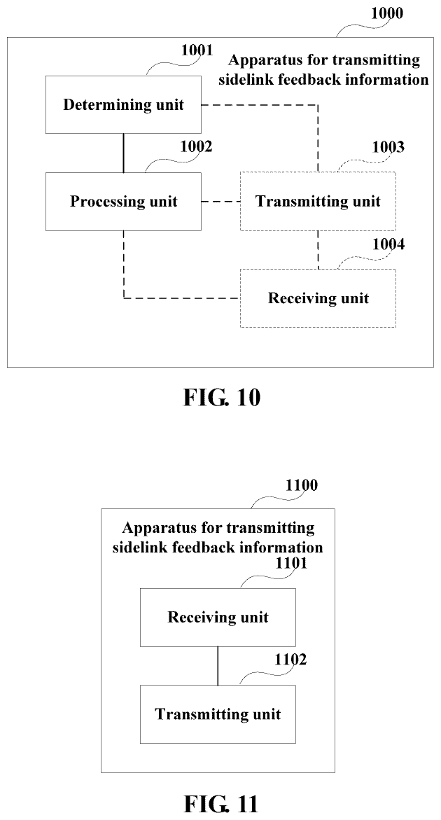

FIG. 10 is a schematic diagram of an apparatus for transmitting sidelink feedback information in the embodiments of the present disclosure. As shown in FIG. 10, an apparatus 1000 for transmitting sidelink feedback information includes:
a determining unit 1001 configured to, in a case where a physical uplink control channel needs to be transmitted to a network device, determine whether sidelink feedback information needing to be carried by the physical uplink control channel is received, and whether a physical sidelink control channel and/or a physical sidelink shared channel associated with the sidelink feedback information has/have been transmitted to a second device; and
a processing unit 1002 configured to not to transmit the physical uplink control channel in a case where the sidelink feedback information needing to be carried by the physical uplink control channel is not received and the physical sidelink control channel and/or the physical sidelink shared channel associated with the sidelink feedback information has/have been transmitted to the second device.

In some embodiments, the processing unit 1002 does not transmit the physical uplink control channel in a case where all sidelink feedback information needing to be carried by the physical uplink control channel is not received and the physical sidelink control channel and/or the physical sidelink shared channel associated with all the sidelink feedback information has/have been transmitted to the second device.

In some embodiments, the processing unit 1002 does not transmit the physical uplink control channel in a case where the number or a proportion of plurality of sidelink feedback information needing to be carried by the physical uplink control channel that is not received is greater than a configured or preconfigured threshold and the physical sidelink control channel and/or the physical sidelink shared channel associated with the plurality of sidelink feedback information has/have been transmitted to the second device.

In some embodiments, as shown in FIG. 10, the apparatus further includes:
a transmitting unit 1003 configured to transmit the physical sidelink control channel and/or the physical sidelink shared channel to the second device.

In some embodiments, as shown in FIG. 10, the apparatus further includes:
a receiving unit 1004 configured to receive information instructing to retransmit the sidelink feedback information transmitted by the network device in a case where the physical uplink control channel is not received.

In some embodiments, a first device is enabled to retransmit the sidelink feedback information to the network device, and the second device is enabled to retransmit the sidelink feedback information to the first device.

In some embodiments, the transmitting unit 1003 further transmits capability information of whether the first device is capable of supporting sidelink feedback information retransmission and/or capability information of whether the second device is capable of supporting sidelink feedback information retransmission to the network device.

In some embodiments, the receiving unit 1004 further receives instruction information transmitted by the network device and used for enabling the first device to perform sidelink feedback information retransmission.

In some embodiments, the receiving unit 1004 further receives capability information of whether the second device is capable of supporting sidelink feedback information retransmission transmitted by the second device.

In some embodiments, the transmitting unit 1003 further transmits instruction information used for enabling the second device to perform sidelink feedback information retransmission to the second device.

In some embodiments, the receiving unit 1004 further receives a plurality of sidelink feedback information transmitted by the second device, wherein physical sidelink feedback channel resources carrying the plurality of sidelink feedback information are determined at least according to the number of the plurality of sidelink feedback information.

In some embodiments, the number of the plurality of sidelink feedback information is determined based on an Assignment Index field in sidelink control information transmitted by the first device to the second device.

In some embodiments, the plurality of sidelink feedback information include: feedback information for a currently-scheduled physical sidelink control channel and/or physical sidelink shared channel, and/or, feedback information for a previously-scheduled physical sidelink control channel and/or physical sidelink shared channel.

In some embodiments, transport blocks carried by the currently-scheduled physical sidelink control channel and/or physical sidelink shared channel are different from transport blocks carried by the previously-scheduled physical sidelink control channel and/or physical sidelink shared channel.

In some embodiments, the physical sidelink feedback channel resources are determined by the following formula:

$$( {P}_{ID} + {M}_{ID} \cdot Q + q ) mod ( {R}_{PRB , CS}^{PSFCH} )$$

where, P_{ID} denotes a physical layer source identifier, M_{ID} denotes an identifier of a member in a group configured by a higher layer, Q denotes the number of the plurality of sidelink feedback information, and q=0,1, . . . , Q−1.

In some embodiments, information indicating grouping and/or retransmission of the sidelink feedback information in the sidelink control information transmitted by the first device to the second device is independent of information indicating grouping and/or retransmission of the sidelink feedback information in downlink control information transmitted by the network device to the first device.

In some embodiments, the receiving unit 1004 further receives information transmitted by the second device, the information indicating the number of physical sidelink feedback channels that the second device is able to transmit simultaneously.

In some embodiments, the plurality of sidelink feedback information is determined as a whole whether to be discarded, and wherein a highest priority in the plurality of sidelink feedback information is used for priority comparison.

Each of the above embodiments is only illustrative for the embodiments of the present disclosure, but the present disclosure is not limited to this, appropriate modifications can be also made based on the above each embodiment. For example, each of the above embodiments may be used individually, or one or more of the above embodiments may be combined.

It's worth noting that the above only describes components or modules related to the present disclosure, but the present disclosure is not limited to this. The apparatus 1000 for transmitting sidelink feedback information may further include other components or modules. For detailed contents of these components or modules, relevant technologies can be referred to.

Moreover, for the sake of simplicity, FIG. 10 only demonstratively shows a connection relationship or signal direction between components or modules, however persons skilled in the art should know that various relevant technologies such as bus connection can be used. The above components or modules can be realized by a hardware facility such as a processor, a memory, a transmitter, a receiver, etc. The embodiments of the present disclosure have no limitation to this.

As can be known from the above embodiments, for HARQ-ACK retransmission from a first device to a network device, if the first device has transmitted a PSCCH and/or PSSCH associated with HARQ-ACK to a second device, but has not received sidelink feedback information needing to be carried by the PUCCH (i.e., the PUCCH does not contain a valid HARQ-ACK bit), the first device does not transmit the PUCCH to the network device, thereby unnecessary occupation of an unlicensed frequency band can be reduced or avoided, and the network device can be notified to schedule HARQ-ACK retransmission. For HARQ-ACK retransmission from the second device to the first device, a size of a HARQ-ACK codebook is additionally used to determine a PSFCH resource, so as to avoid a PSFCH resource collision during HARQ-ACK retransmission of multicast.

### Embodiments of a Fourth Aspect

The embodiments of the present disclosure provide an apparatus for transmitting sidelink feedback information. The apparatus e.g. may be a terminal equipment (such as the above mentioned second device), or it may be one or more parts or components configured on the terminal equipment. The contents same as the embodiments of the first and second aspects are not repeated.

FIG. 11 is a schematic diagram of an apparatus for transmitting sidelink feedback information in the embodiments of the present disclosure. As shown in FIG. 11, an apparatus 1100 for transmitting sidelink feedback information includes:
a receiving unit 1101 configured to receive a physical sidelink control channel and/or physical sidelink shared channel transmitted by a first device; and
a transmitting unit 1102 configured to transmit a plurality of sidelink feedback information to the first device, wherein physical sidelink feedback channel resources of the plurality of sidelink feedback information are determined at least according to the number of the plurality of sidelink feedback information.

In some embodiments, transmitting unit 1102 determines the number of the plurality of sidelink feedback information based on an Assignment Index field in sidelink control information transmitted by the first device to the second device.

In some embodiments, the plurality of sidelink feedback information include: feedback information for a currently-scheduled physical sidelink control channel (PSCCH) and/or physical sidelink shared channel (PSSCH), and/or, feedback information for a previously-scheduled physical sidelink control channel (PSCCH) and/or physical sidelink shared channel (PSSCH).

In some embodiments, transport blocks (TB) carried by the currently-scheduled physical sidelink control channel (PSCCH) and/or physical sidelink shared channel (PSSCH) are different from transport blocks (TB) carried by the previously-scheduled physical sidelink control channel (PSCCH) and/or physical sidelink shared channel (PSSCH).

In some embodiments, the physical sidelink feedback channel (PSFCH) resources are determined by the following formula:

$$( {P}_{ID} + {M}_{ID} \cdot Q + q ) mod ( {R}_{PRB , CS}^{PSFCH} )$$

where, P_{ID} denotes a physical layer source identifier (physical layer source ID), M_{ID} denotes an identifier of a member in a group (group member ID) configured by a higher layer, Q denotes the number of the plurality of sidelink feedback information, and q=0,1, . . . , Q−1.

In some embodiments, the transmitting unit 1102 determines not to feed back sidelink feedback information based on an instruction from the first device, or determines not to feed back the sidelink feedback information in a case where a physical sidelink feedback channel (PSFCH) carrying the sidelink feedback information is located outside a channel holding time.

In some embodiments, information indicating grouping and/or retransmission of the sidelink feedback information in the sidelink control information (SCI) transmitted by the first device to the second device is independent of information indicating grouping and/or retransmission of the sidelink feedback information in downlink control information (DCI) transmitted by the network device to the first device.

In some embodiments, the transmitting unit 1102 transmits information to the first device, the information indicating the number of PSFCHs that the second device is able to transmit simultaneously.

In some embodiments, the transmitting unit 1102 determines the plurality of sidelink feedback information as a whole whether to be discarded, and wherein a highest priority in the plurality of sidelink feedback information is used for priority comparison.

Each of the above embodiments is only illustrative for the embodiments of the present disclosure, but the present disclosure is not limited to this, appropriate modifications can be also made based on the above each embodiment. For example, each of the above embodiments may be used individually, or one or more of the above embodiments may be combined.

It's worth noting that the above only describes components or modules related to the present disclosure, but the present disclosure is not limited to this. The apparatus 1100 for transmitting sidelink feedback information may further include other components or modules. For detailed contents of these components or modules, relevant technologies can be referred to.

Moreover, for the sake of simplicity, FIG. 11 only demonstratively shows a connection relationship or signal direction between components or modules, however persons skilled in the art should know that various relevant technologies such as bus connection can be used. The above components or modules can be realized by a hardware facility such as a processor, a memory, a transmitter, a receiver, etc. The embodiments of the present disclosure have no limitation to this.

As can be known from the above embodiments, for HARQ-ACK retransmission from a first device to a network device, if the first device has transmitted a PSCCH and/or PSSCH associated with HARQ-ACK to a second device, but has not received sidelink feedback information needing to be carried by the PUCCH (i.e., the PUCCH does not contain a valid HARQ-ACK bit), the first device does not transmit the PUCCH to the network device, thereby unnecessary occupation of an unlicensed frequency band can be reduced or avoided, and the network device can be notified to schedule HARQ-ACK retransmission. For HARQ-ACK retransmission from the second device to the first device, a size of a HARQ-ACK codebook is additionally used to determine a PSFCH resource, so as to avoid a PSFCH resource collision during HARQ-ACK retransmission of multicast.

### Embodiments of a Fifth Aspect

The embodiments of the present disclosure further provide a communication system, FIG. 1 can be referred to, the contents same as the embodiments of the first to fourth aspects are not repeated.

In some embodiments, the communication system 100 at least may include:
a first device configured to, in a case where a physical uplink control channel needs to be transmitted to a network device, determine whether sidelink feedback information needing to be carried by the physical uplink control channel is received, and whether a physical sidelink control channel and/or a physical sidelink shared channel associated with the sidelink feedback information has/have been transmitted to a second device, and not to transmit the physical uplink control channel in a case where the sidelink feedback information needing to be carried by the physical uplink control channel is not received and the physical sidelink control channel and/or the physical sidelink shared channel associated with the sidelink feedback information has/have been transmitted to the second device; and/or
a second device configured to receive a physical sidelink control channel and/or physical sidelink shared channel transmitted by the first device, and transmit a plurality of sidelink feedback information to the first device, wherein physical sidelink feedback channel resources of the plurality of sidelink feedback information are determined at least according to the number of the plurality of sidelink feedback information.

The embodiments of the present disclosure further provide a network device, for example may be a base station, but the present disclosure is not limited to this, it may also be other network device.

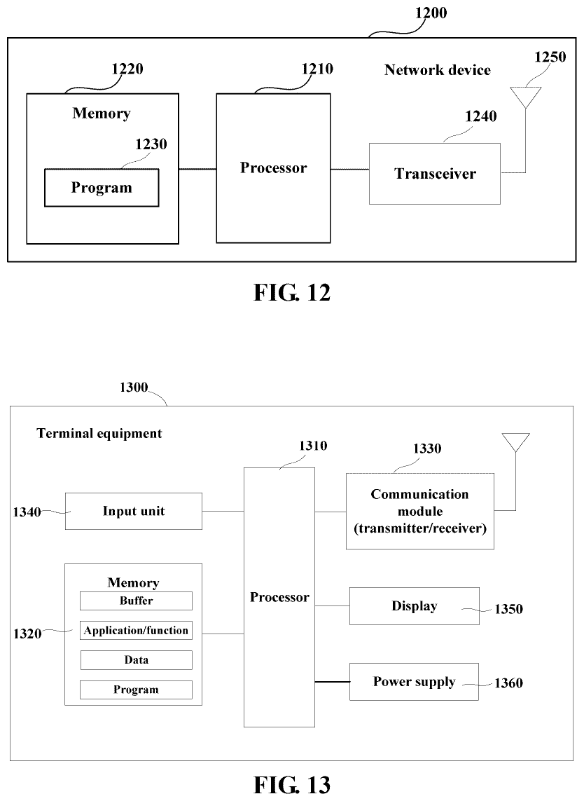

FIG. 12 is a composition schematic diagram of a network device in the embodiments of the present disclosure. As shown in FIG. 12, the network device 1200 may include: a processor 1210 (such as a central processing unit (CPU)) and a memory 1220; the memory 1220 is coupled to the processor 1210. The memory 1220 can store various data; moreover, also stores a program 1230 for information processing, and executes the program 1230 under the control of the processor 1210.

For example, the processor 1210 can be configured to execute a program to implement the method for receiving sidelink feedback information as described in the embodiments of the first aspect. For example, the processor 1210 may be configured to perform the following control: receiving sidelink feedback information from a first device and carried by a physical uplink control channel; wherein the physical uplink control channel (PUCCH) is transmitted by the first device in a case where it is determined that the sidelink feedback information needing to be carried by the physical uplink control channel has been received.

In addition, as shown in FIG. 12, the network device 1200 may further include: a transceiver 1240 and an antenna 1250, etc.; wherein the functions of said components are similar to relevant arts, which are not repeated here. It's worth noting that the network device 1200 does not have to include all the components shown in FIG. 12. Moreover, the network device 1200 may also include components not shown in FIG. 12, relevant arts can be referred to.

The embodiments of the present disclosure further provide a terminal equipment, but the present disclosure is not limited to this, it may also be other device.

FIG. 13 is a schematic diagram of a terminal equipment in the embodiments of the present disclosure. As shown in FIG. 13, the terminal equipment 1300 may include a processor 1310 and a memory 1320; the memory 1320 stores data and programs, and is coupled to the processor 1310. It's worth noting that this figure is exemplary; other types of structures can also be used to supplement or replace this structure, so as to realize a telecommunication function or other functions.

For example, the processor 1310 can be configured to execute a program to implement the method for transmitting sidelink feedback information as described in the embodiments of the first aspect. For example, the processor 1310 may be configured to perform the following control: in a case where a physical uplink control channel (PUCCH) needs to be transmitted to a network device, determining whether sidelink feedback information needing to be carried by the physical uplink control channel is received, and whether a physical sidelink control channel (PSCCH) and/or a physical sidelink shared channel (PSSCH) associated with the sidelink feedback information has/have been transmitted to a second device, and not transmitting the physical uplink control channel (PUCCH) in a case where the sidelink feedback information needing to be carried by the physical uplink control channel is not received and the physical sidelink control channel (PSCCH) and/or the physical sidelink shared channel ((PSSCH)) associated with the sidelink feedback information has/have been transmitted to the second device.

For example, the processor 1310 can be configured to execute a program to implement the method for transmitting sidelink feedback information as described in the embodiments of the second aspect. For example, the processor 1310 may be configured to perform the following control: receiving a physical sidelink control channel (PSCCH) and/or physical sidelink shared channel (PSSCH) transmitted by the first device, and transmitting a plurality of sidelink feedback information to the first device, wherein physical sidelink feedback channel (PSFCH) resources of the plurality of sidelink feedback information are determined at least according to the number of the plurality of sidelink feedback information.

As shown in FIG. 13, the terminal equipment 1300 may further include: a communication module 1330, an input unit 1340, a display 1350 and a power source 1360. The functions of said components are similar to prior arts, which are not repeated here. It's worth noting that the terminal equipment 1300 does not have to include all the components shown in FIG. 13, said components are not indispensable. Moreover, the terminal equipment 1300 may also include components not shown in FIG. 13, prior arts can be referred to.

The embodiments of the present disclosure further provide a computer program, wherein when a terminal device executes the program, the program enables the terminal device to execute the method for transmitting sidelink feedback information described in the embodiments of the first and second aspects.

The embodiments of the present disclosure further provide a storage medium in which a computer program is stored, wherein the computer program enables a terminal device to execute the method for transmitting sidelink feedback information described in the embodiments of the first and second aspects.

The embodiments of the present disclosure further provide a computer program, wherein when a network device executes the program, the program enables the network device to execute the method for receiving sidelink feedback information described in the embodiments of the first aspect.

The embodiments of the present disclosure further provide a storage medium in which a computer program is stored, wherein the computer program enables a network device to execute the method for receiving sidelink feedback information described in the embodiments of the first aspect.

The apparatus and method in the present disclosure can be realized by hardware, or can be realized by combining hardware with software. The present disclosure relates to such a computer readable program, when the program is executed by a logic component, the computer readable program enables the logic component to realize the apparatus described in the above text or a constituent component, or enables the logic component to realize various methods or steps described in the above text. The present disclosure also relates to a storage medium storing the program, such as a hard disk, a magnetic disk, an optical disk, a DVD, a flash memory and the like.

By combining with the method/apparatus described in the embodiments of the present disclosure, it can be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules can be realized by solidifying these software modules e.g. using a field-programmable gate array (FPGA).

A software module can be located in a RAM memory, a flash memory, a ROM memory, an EPROM memory, an EEPROM memory, a register, a hard disk, a mobile magnetic disk, a CD-ROM or a storage medium in any other form as known in this field. A storage medium can be coupled to a processor, thereby enabling the processor to read information from the storage medium, and to write the information into the storage medium; or the storage medium can be a constituent part of the processor. The processor and the storage medium can be located in an ASIC. The software module can be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module can be stored in the MEGA-SIM card or the flash memory apparatus with a large capacity.

One or more in the functional block diagram or one or more combinations in the functional block diagram as described in the drawings can be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings can be also implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art can make various variations and modifications to the present disclosure based on the spirit and principle of the present disclosure, these variations and modifications are also within the scope of the present disclosure.

As for the implementations including the above embodiments, the following supplements are further disclosed:

Supplement 1. A method for transmitting sidelink feedback information, including:
in a case where a physical uplink control channel (PUCCH) needs to be transmitted to a network device, determining, by a first device, whether sidelink feedback information needing to be carried by the physical uplink control channel is received, and whether a physical sidelink control channel (PSCCH) and/or a physical sidelink shared channel (PSSCH) associated with the sidelink feedback information has/have been transmitted to a second device; and
not transmitting, by the first device, the physical uplink control channel (PUCCH) in a case where the sidelink feedback information needing to be carried by the physical uplink control channel is not received and the physical sidelink control channel (PSCCH) and/or the physical sidelink shared channel (PSSCH) associated with the sidelink feedback information has/have been transmitted to the second device.

Supplement 2. The method according to Supplement 1, wherein the first device does not transmit the physical uplink control channel (PUCCH) in a case where all sidelink feedback information needing to be carried by the physical uplink control channel is not received and the physical sidelink control channel (PSCCH) and/or the physical sidelink shared channel (PSSCH) associated with all the sidelink feedback information has/have been transmitted to the second device.

Supplement 3. The method according to Supplement 1, wherein the first device does not transmit the physical uplink control channel (PUCCH) in a case where the number or a proportion of a plurality of sidelink feedback information needing to be carried by the physical uplink control channel that is not received is greater than a configured or preconfigured threshold and the physical sidelink control channel (PSCCH) and/or the physical sidelink shared channel (PSSCH) associated with the plurality of sidelink feedback information has/have been transmitted to the second device.

Supplement 4. The method according to any one of Supplements 1 to 3, wherein the method further includes:
receiving, by the first device, information instructing to retransmit the sidelink feedback information transmitted by the network device in a case where the physical uplink control channel is not received.

Supplement 5. The method according to any one of Supplements 1 to 4, wherein the first device is enabled to retransmit the sidelink feedback information to the network device, and the second device is enabled to retransmit the sidelink feedback information to the first device.

Supplement 6. The method according to any one of Supplements 1 to 5, wherein the method further includes:
transmitting, by the first device, capability information of whether the first device is capable of supporting sidelink feedback information retransmission and/or capability information of whether the second device is capable of supporting sidelink feedback information retransmission to the network device.

Supplement 7. The method according to any one of Supplements 1 to 6, wherein the method further includes:
receiving, by the first device, instruction information transmitted by the network device and used for enabling the first device to perform sidelink feedback information retransmission.

Supplement 8. The method according to any one of Supplements 1 to 7, wherein the method further includes:
receiving, by the first device, capability information of whether the second device is capable of supporting sidelink feedback information retransmission transmitted by the second device.

Supplement 9. The method according to any one of Supplements 1 to 8, wherein the method further includes:
transmitting, by the first device, instruction information used for enabling the second device to perform sidelink feedback information retransmission to the second device.

Supplement 10. The method according to any one of Supplements 1 to 9, wherein the method further includes:
transmitting, by the first device, non-acknowledgment (NACK) information to the network device in a case where the physical sidelink controls the channel (PSCCH) and/or the physical sidelink shared channel (PSSCH) are/is not transmitted to a second device due to an LBT failure.

Supplement 11. The method according to any one of Supplements 1 to 10, wherein the method further includes:
receiving, by the first device, a plurality of sidelink feedback information transmitted by the second device, wherein physical sidelink feedback channel (PSFCH) resources carrying the plurality of sidelink feedback information are determined at least according to the number of the plurality of sidelink feedback information.

Supplement 12. The method according to Supplement 11, wherein the number of the plurality of sidelink feedback information is determined based on an Assignment Index (AI) field in sidelink control information transmitted by the first device to the second device.

Supplement 13. The method according to Supplement 11 or 12, wherein the plurality of sidelink feedback information include: feedback information for a currently-scheduled physical sidelink control channel (PSCCH) and/or physical sidelink shared channel (PSSCH), and/or, feedback information for a previously-scheduled physical sidelink control channel (PSCCH) and/or physical sidelink shared channel (PSSCH).

Supplement 14. The method according to Supplement 13, wherein transport blocks (TB) carried by the currently-scheduled physical sidelink control channel (PSCCH) and/or physical sidelink shared channel (PSSCH) are different from transport blocks (TB) carried by the previously-scheduled physical sidelink control channel (PSCCH) and/or physical sidelink shared channel (PSSCH).

Supplement 15. The method according to any one of Supplements 11 to 14, wherein the physical sidelink feedback channel (PSFCH) resources are determined by the following formula:

$$( {P}_{ID} + {M}_{ID} \cdot Q + q ) mod ( {R}_{PRB , CS}^{PSFCH} )$$

where, P_{ID} denotes a physical layer source identifier (physical layer source ID), M_{ID} denotes an identifier of a member in a group (group member ID) configured by a higher layer, Q denotes the number of the plurality of sidelink feedback information, and q=0,1, . . . , Q−1.

Supplement 16. The method according to any one of Supplements 11 to 15, wherein information indicating grouping and/or retransmission of the sidelink feedback information in the sidelink control information (SCI) transmitted by the first device to the second device is independent of information indicating grouping and/or retransmission of the sidelink feedback information in downlink control information (DCI) transmitted by the network device to the first device.

Supplement 17. The method according to any one of Supplements 11 to 16, wherein the method further includes:
receiving, by the first device, information indicating the number of PSFCHs that the second device is able to transmit simultaneously transmitted by the second device.

Supplement 18. The method according to any one of Supplements 11 to 17, wherein the plurality of sidelink feedback information is determined as a whole whether to be discarded, and wherein a highest priority in the plurality of sidelink feedback information is used for priority comparison.

Supplement 19. The method according to any one of Supplements 1 to 18, wherein the method further includes:
transmitting, by the first device, the physical sidelink control channel (PSCCH) and/or physical sidelink shared channel (PSSCH) to the second device;

Supplement 20. A method for transmitting sidelink feedback information, including:
receiving, by a second device, a physical sidelink control channel (PSCCH) and/or physical sidelink shared channel (PSSCH) transmitted by a first device; and
transmitting, by the second device, a plurality of sidelink feedback information to the first device, wherein physical sidelink feedback channel (PSFCH) resources of the plurality of sidelink feedback information are determined at least according to the number of the plurality of sidelink feedback information.

Supplement 21. The method according to Supplement 20, wherein the method further includes:
determining, by the second device, the number of the plurality of sidelink feedback information based on an Assignment Index field in sidelink control information transmitted by the first device to the second device.

Supplement 22. The method according to Supplement 20 or 21, wherein the plurality of sidelink feedback information include: feedback information for a currently-scheduled physical sidelink control channel (PSCCH) and/or physical sidelink shared channel (PSSCH), and/or, feedback information for a previously-scheduled physical sidelink control channel (PSCCH) and/or physical sidelink shared channel (PSSCH).

Supplement 23. The method according to Supplement 22, wherein transport blocks (TB) carried by the currently-scheduled physical sidelink control channel (PSCCH) and/or physical sidelink shared channel (PSSCH) are different from transport blocks (TB) carried by the previously-scheduled physical sidelink control channel (PSCCH) and/or physical sidelink shared channel (PSSCH).

Supplement 24. The method according to any one of Supplements 20 to 23, wherein the physical sidelink feedback channel (PSFCH) resources are determined by the following formula:

$$( {P}_{ID} + {M}_{ID} \cdot Q + q ) mod ( {R}_{PRB , CS}^{PSFCH} )$$

where, P_{ID} denotes a physical layer source identifier (physical layer source ID), M_{ID} denotes an identifier of a member in a group (group member ID) configured by a higher layer, Q denotes the number of the plurality of sidelink feedback information, and q=0,1, . . . , Q−1.

Supplement 25. The method according to any one of Supplements 20 to 24, wherein the method further includes:
determining, by the second device, not to feed back sidelink feedback information based on an instruction from the first device, or determines not to feed back the sidelink feedback information in a case where a physical sidelink feedback channel (PSFCH) carrying the sidelink feedback information is located outside a channel holding time.

Supplement 26. The method according to any one of Supplements 20 to 25, wherein information indicating grouping and/or retransmission of sidelink feedback information in the sidelink control information (SCI) transmitted by the first device to the second device is independent of information indicating grouping and/or retransmission of the sidelink feedback information in downlink control information (DCI) transmitted by the network device to the first device.

Supplement 27. The method according to any one of Supplements 20 to 26, wherein the method further includes:
transmitting, by the second device, information indicating the number of PSFCHs that the second device is able to transmit simultaneously to the first device.

Supplement 28. The method according to any one of Supplements 20 to 27, wherein the method further includes:
determining, by the second device, the plurality of sidelink feedback information as a whole whether to be discarded, and wherein a highest priority in the plurality of sidelink feedback information is used for priority comparison.

Supplement 29. A method for transmitting sidelink feedback information, including:
determining, by the first device, whether sidelink feedback information needing to be carried by the physical uplink control channel is valid or whether it is a filling bit in a case where the first device needs to transmit the physical sidelink control channel (PSCCH) to a network device;
not transmitting, by the first device, the physical uplink control channel (PUCCH) in a case where sidelink feedback information needing to be carried by the physical uplink control channel are invalid or are filling bits.

Supplement 30. The method according to Supplement 29, wherein the first device determines that the sidelink feedback information is invalid or is a filling bit in a case where the sidelink feedback information is not received and the physical sidelink control channel (PSCCH) and/or the physical sidelink shared channel (PSSCH) associated with the sidelink feedback information has/have been transmitted to the second device.

Supplement 31. The method according to Supplement 29, wherein the first device does not transmit the physical uplink control channel (PUCCH) in a case where all sidelink feedback information needing to be carried by the physical uplink control channel are invalid or are filling bits.

Supplement 32. The method according to Supplement 29, wherein the first device does not transmit the physical uplink control channel (PUCCH) in a case where the number or a proportion of invalid sidelink feedback information in a plurality of sidelink feedback information needing to be carried by the physical uplink control channel or the number or a proportion of filling bits is greater than a configured or preconfigured threshold.

Supplement 33. A method for receiving sidelink feedback information, including:
receiving, by a network device, sidelink feedback information carried by a first device via a physical uplink control channel;
wherein the physical uplink control channel (PUCCH) is transmitted by the first device in a case where it is determined that the sidelink feedback information needing to be carried by the physical uplink control channel has been received.

Supplement 34. The method according to Supplement 33, wherein the physical uplink control channel (PUCCH) is not transmitted by the first device in a case where the sidelink feedback information needing to be carried by the physical uplink control channel is not received by the first device, and the first device has transmitted a physical sidelink control channel (PSCCH) and/or a physical sidelink shared channel (PSSCH) associated with the sidelink feedback information to the second device.

Supplement 35. The method according to Supplement 34, wherein the physical uplink control channel (PUCCH) is not transmitted by the first device in a case where all the sidelink feedback information needing to be carried by the physical uplink control channel is not received by the first device, and the first device has transmitted a physical sidelink control channel (PSCCH) and/or a physical sidelink shared channel (PSSCH) associated with all the sidelink feedback information to the second device.

Supplement 36. The method according to Supplement 34, wherein the physical uplink control channel (PUCCH) is not transmitted by the first device in a case where the number or a proportion of a plurality of sidelink feedback information needing to be carried by the physical uplink control channel that is not received by the first device is greater than a configured or preconfigured threshold, and the first device has transmitted the physical sidelink control channel (PSCCH) and/or the physical sidelink shared channel (PSSCH) associated with the plurality of sidelink feedback information to the second device.

Supplement 37. The method according to any one of Supplements 33 to 36, wherein the method further includes:
transmitting, by the network device, information instructing to retransmit the sidelink feedback information to the first device in a case where the physical uplink control channel is not received.

Supplement 38. The method according to any one of Supplements 33 to 37, wherein the first device is enabled to retransmit the sidelink feedback information to the network device, and the second device is enabled to retransmit the sidelink feedback information to the first device.

Supplement 39. The method according to any one of Supplements 33 to 38, wherein the method further includes:
receiving, by the network device, capability information of whether the first device is capable of supporting sidelink feedback information retransmission and/or capability information of whether the second device is capable of supporting sidelink feedback information retransmission as transmitted by the first device.

Supplement 40. The method according to any one of Supplements 33 to 39, wherein the method further includes:
transmitting, by the network device, instruction information used for enabling the first device to perform sidelink feedback information retransmission to the first device.

Supplement 41. A terminal equipment, including a memory and a processor, the memory storing a computer program, and the processor being configured to execute the method for transmitting sidelink feedback information according to any one of Supplements 1 to 32.

Supplement 42. A network device, including a memory and a processor, the memory storing a computer program, and the processor being configured to execute the method for receiving sidelink feedback information according to any one of Supplements 33 to 40.

1. A first terminal device, comprising:
processor circuitry configured to perform a LBT; and
a transmitter configured to transmits NACK to a network device when, due to a failure of the LBT, the first terminal device does not transmit a PSSCH to a second terminal device on a resource scheduled by a DCI or a resource of a configured grant.

2. The first terminal device according to claim 1, wherein the processor circuitry performs the LBT for transmitting the PSSCH to the second terminal device.

3. The first terminal device according to claim 1, wherein the device further comprises:
a receiver configured to receive a plurality of sidelink feedback information transmitted by the second terminal device, wherein one or more PSFCH resources carrying the plurality of sidelink feedback information are determined at least according to the number of the plurality of sidelink feedback information.

4. The first terminal device according to claim 3, wherein the number of the plurality of sidelink feedback information is determined based on an Assignment Index field in sidelink control information transmitted by the first terminal device to the second terminal device.

5. The first terminal device according to claim 3, wherein the plurality of sidelink feedback information comprise: feedback information for a currently-scheduled PSCCH and/or PSSCH, and/or, feedback information for a previously-scheduled PSCCH and/or PSSCH.

6. The first terminal device according to claim 5, wherein transport blocks (TB) carried by the currently-scheduled PSCCH and/or PSSCH are different from transport blocks (TB) carried by the previously-scheduled PSCCH and/or PSSCH.

7. The first terminal device according to claim 3, wherein the PSFCH resources are determined by the following formula:
$$( {P}_{ID} + {M}_{ID} \cdot Q + q ) mod ( {R}_{PRB , CS}^{PSFCH} )$$
where, P_{ID} denotes a physical layer source identifier, M_{ID} denotes an identifier of a member in a group configured by a higher layer, Q denotes the number of the plurality of sidelink feedback information, and q=0,1, . . . , Q−1.

8. The first terminal device according to claim 3, wherein information indicating grouping and/or retransmission of the sidelink feedback information in sidelink control information (SCI) transmitted by the first terminal device to the second terminal device is independent of information indicating grouping and/or retransmission of the sidelink feedback information in downlink control information (DCI) transmitted by the network device to the first terminal device.

9. The first terminal device according to claim 3, wherein the receiver further configured to receive information transmitted by the second terminal device, the information indicating the number of PSFCHs that the second terminal device is able to transmit simultaneously.

10. The first terminal device according to claim 3, wherein the plurality of sidelink feedback information is determined as a whole whether to be discarded, and wherein a highest priority in the plurality of sidelink feedback information is used for priority comparison.

11. The first terminal device according to claim 1, wherein the transmitter is further configured to transmit the PSCCH and/or PSSCH to the second terminal device.

12. A method for transmitting sidelink feedback information, comprising:
performing, by a first terminal device, a LBT;
transmitting, by the first terminal device, NACK to a network device when, due to a failure of the LBT, the first terminal device does not transmit a PSSCH to a second terminal device on a resource scheduled by a DCI or a resource of a configured grant.

13. The method according to claim 12, wherein the method further comprises:
receiving, by the terminal device, a plurality of sidelink feedback information transmitted by the second terminal device, wherein one or more PSFCH resources carrying the plurality of sidelink feedback information are determined at least according to the number of the plurality of sidelink feedback information.

14. The method according to claim 13, wherein the number of the plurality of sidelink feedback information is determined based on an Assignment Index field in sidelink control information transmitted by the first terminal device to the second terminal device.

15. The method according to claim 13, wherein the plurality of sidelink feedback information comprise: feedback information for a currently-scheduled PSCCH and/or PSSCH, and/or, feedback information for a previously-scheduled PSCCH and/or PSSCH.

16. The method according to claim 15, wherein transport blocks (TB) carried by the currently-scheduled PSCCH and/or PSSCH are different from transport blocks (TB) carried by the previously-scheduled PSCCH and/or PSSCH.

17. The method according to claim 13, wherein the PSFCH resources are determined by the following formula:
$$( {P}_{ID} + {M}_{ID} \cdot Q + q ) mod ( {R}_{PRB , CS}^{PSFCH} )$$
where, P_{ID} denotes a physical layer source identifier, M_{ID} denotes an identifier of a member in a group configured by a higher layer, Q denotes the number of the plurality of sidelink feedback information, and q=0,1, . . . , Q−1.

18. The method according to claim 13, wherein information indicating grouping and/or retransmission of the sidelink feedback information in sidelink control information (SCI) transmitted by the first terminal device to the second terminal device is independent of information indicating grouping and/or retransmission of the sidelink feedback information in downlink control information (DCI) transmitted by the network device to the first terminal device.

19. The method according to claim 13, wherein the method further comprises:
receiving, by the first terminal device, information transmitted by the second terminal device, the information indicating the number of PSFCHs that the second terminal device is able to transmit simultaneously;
wherein the plurality of sidelink feedback information is determined as a whole whether to be discarded, and wherein a highest priority in the plurality of sidelink feedback information is used for priority comparison.

20. A communication system, comprising:
a first terminal device, a second terminal device and a network device;
wherein the first terminal device performs a LBT; transmits NACK to the network device when, due to a failure of the LBT, the first terminal device does not transmit a PSSCH to the second terminal device on a resource scheduled by a DCI or a resource of a configured grant.
